(19) United States
(12) Patent Application Publication
(10) Pub. No.: US 2025/0380182 A1
(43) Pub. Date: Dec. 11, 2025

(54) TECHNOLOGIES FOR DYNAMIC ON-DEMAND NETWORK SLICING

(71) Applicant: Apple Inc., Cupertino, CA (US)

(72) Inventors: Aimin J. Sang, Santa Clara, CA (US); Ajoy K. Singh, Milpitas, CA (US); Yingjie Zhao, Pleasanton, CA (US); Erdogan Dede, San Diego, CA (US); Faraz Faheem, Santa Clara, CA (US); Vinay Mysore Viswanath, San Diego, CA (US); Yifan Zhu, Los Gatos, CA (US)

(73) Assignee: Apple Inc., Cupertino, CA (US)

(21) Appl. No.: 19/204,256

(22) Filed: May 9, 2025

Related U.S. Application Data
(60) Provisional application No. 63/658,743, filed on Jun. 11, 2024.
(60) Provisional application No. 63/682,329, filed on Aug. 12, 2024.

(51) Int. Cl. H04W 28/02; H04W 48/18

(52) U.S. Cl. CPC H04W 28/0268; H04W 48/18

(57) ABSTRACT

The present application relates to devices and components including apparatus, systems, and methods for user equipment (UE) triggered network slicing.

### CROSS-REFERENCES TO OTHER APPLICATIONS

This application claims priority to U.S. Provisional Application No. 63/658,743, for “TECHNOLOGIES FOR DYNAMIC ON-DEMAND NETWORK SLICING” filed on Jun. 11, 2024 and U.S. Provisional Application No. 63/682,329, for “PROACTIVELY REGISTERING A USER-PREFERRED NETWORK SLICE” filed Aug. 12, 2024, which are herein incorporated by reference in their entirety for all purposes.

### TECHNICAL FIELD

This application relates generally to communication networks and, in particular, to user equipment (UE) triggered network slicing.

### BACKGROUND

Third Generation Partnership Project (3GPP) Technical Specifications (TSs) define standards for wireless networks. These TSs describe aspects related to user plane and control plane signaling over the networks.

### BRIEF DESCRIPTION OF THE DRAWINGS

FIG. 1 illustrates a network environment in accordance with some embodiments.

FIG. 2 illustrates a slicing diagram in accordance with some embodiments.

FIG. 3 illustrates an example solution for slicing in accordance with some embodiments.

FIG. 4 illustrates a network environment in accordance with some embodiments.

FIG. 5 illustrates an example solution for slicing in accordance with some embodiments.

FIG. 6 illustrates a signaling diagram in accordance with some embodiments.

FIG. 7 illustrates an operation flow/algorithmic structure in accordance with some embodiments.

FIG. 8 illustrates another operation flow/algorithmic structure in accordance with some embodiments.

FIG. 9 illustrates another operation flow/algorithmic structure in accordance with some embodiments.

FIG. 10 illustrates an example of proactively enabling a network slice, in accordance with some embodiments.

FIG. 11 illustrates an example of a sequence diagram for enabling a network slice, in accordance with some embodiments.

FIG. 12 illustrates another example of a sequence diagram for enabling a network slice, in accordance with some embodiments.

FIG. 13 illustrates an example of a sequence diagram for proactively enabling a network slice, in accordance with some embodiments.

FIG. 14 illustrates another example of a sequence diagram for proactively enabling a network slice, in accordance with some embodiments.

FIG. 15 illustrates an example of an operational flow/algorithmic structure for proactively enabling a network slice, in accordance with some embodiments.

FIG. 16 illustrates an example of an operational flow/algorithmic structure for proactively determining that a network slice is to be allowed, in accordance with some embodiments.

FIG. 17 illustrates an example of an operational flow/algorithmic structure for proactively allowing a network slice, in accordance with some embodiments.

FIG. 18 illustrates a user equipment in accordance with some embodiments.

FIG. 19 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and techniques to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry,” as used herein, refers to, is part of, or includes hardware components that are configured to provide the described functionality. The hardware components may include an electronic circuit, a logic circuit, a processor (shared, dedicated, or group) or memory (shared, dedicated, or group), an application-specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry,” as used herein, refers to, is part of, or includes circuitry capable of sequentially and automatically carrying out a sequence of arithmetic or logical operations, recording, storing, or transferring digital data. The term “processor circuitry” may refer to an application processor, baseband processor, central processing unit (CPU), graphics processing unit, single-core processor, dual-core processor, triple-core processor, quad-core processor, or any other device capable of executing or otherwise operating computer-executable instructions, such as program code, software modules, or functional processes.

The term “interface circuitry,” as used herein, refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any transmission medium, either tangible or intangible, that is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, or a virtualized network function.

The term “information element” refers to a structural element containing one or more fields. The term “field” refers to individual contents of an information element or a data element that contains content. An information element may include one or more additional information elements.

Network slicing partitions physical network infrastructures into independent logical or virtualized networks called network slices. Each network slice may be an isolated end-to-end network customized to fulfill the requirements of a particular application or application type (e.g., gaming, video streaming, real-time multimedia streaming). Network slicing may also enable operators to serve groups of users with specific service requirements. For example, network operators may allocate a slice to provide coverage for users attending an event, e.g., a game in a stadium.

A network slice may include configurations for services and capabilities offered by the slice to meet specific quality of service (QOS) or quality of experience (QoE) parameters. In addition, the network slice may include one or more network functions to deliver the services, e.g., access and mobility management function (AMF), session management function (SMF), or user plane function (UPF). Furthermore, the network slice may also include physical or virtual resources to deploy and operate the network functions, e.g., software-defined networking (SDN), network function virtualization (NFV), or various network elements.

Network slices may be designed to be independent and logically separated from one another. The isolation of network slices may prevent performance or issues in one slice from affecting other slices, which allows operators to maintain the QoS, QoE, or security of each slice's intended purpose.

Configuration of network slices may involve creating, updating, reconfiguring, or deleting network slice instances (NSIs). In slice creation, the network may define parameters for each slice, including bandwidth, latency, and security attributes or parameters. The network may also configure dedicated resources allocated to each slice. Finally, the configuration may configure network functions, management, or control entities associated with the slice.

A user equipment (UE) may map application data, e.g., service data flows (SDFs), to network slices based on service level agreements (SLAs) or QoS/QoE parameters of the application or application data. For example, the network may use network slice selection assistance information (S-NSSAI) to help the UE identify and select the appropriate slice for its data flows. In some instances, the UE may map application data to network slices based on a traffic classifier. The traffic classifier may identify the class of data flow and may allow adaptive slicing. For example, data flows may be classified as real-time multimedia, real-time emergency responder's data, edge services, or time-sensitive networking (TSN) data flows.

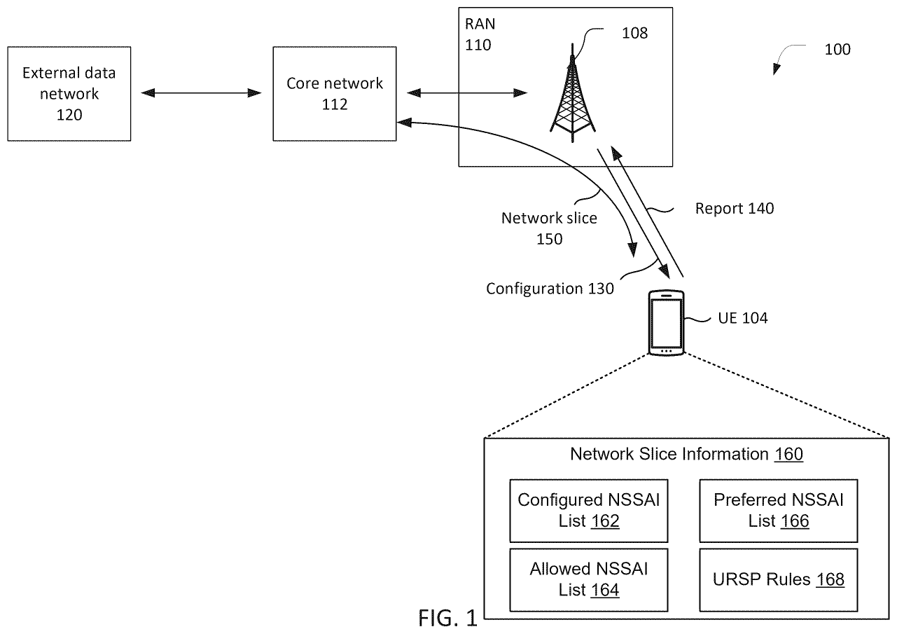

FIG. 1 illustrates a network environment 100 in accordance with some embodiments. The network environment 100 may include a UE 104 communicatively coupled with a base station (BS) 108 of a radio access network (RAN) 110. The UE 104 and the base station 108 may communicate over air interfaces compatible with 3GPP TSs, such as those that define a Fifth Generation (5G) new radio (NR) system or a later system. The base station 108 may provide user plane and control plane protocol terminations toward the UE 104.

The network environment 100 may further include a core network 112. For example, the core network 112 may comprise a 5th Generation Core network (5GC) or a later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions.

The core network 112 (e.g., a function thereof) can configure and allow one or more network slices for the UE 104. Generally, network slicing enables the multiplexing of virtualized and independent logical networks on the same physical network infrastructure. In particular, the UE 104 can receive and store network slice information 106 about the one or more network slices. Each network slice can be an isolated end-to-end network configured to meet requirements of applications executable at by the UE 104. Each network slice can provide different levels of quality of service (QOS), security, and/or throughput. Based on the network slice information 106, the UE 104 can manage the use of the one or more network slices by the applications. In particular, a network slice can be established between the UE 104 and the network (e.g., between the UE 104 and a function of the core network 112 via the base station 102). This network slice can be used for slice traffic to and from the UE 104 (e.g., via a PDU session of the network slice).

The network environment 100 may include a network slice, for example, the network slice 150. The network slice 150 may carry the data traffic. The data traffic associated with an application may be referred to as an SDF. An SDF may include uplink (UL) or downlink (DL) data traffic. For example, in a video call, the UE 104 may send video packets in UL transmissions to the external data network 120 via the base station 108 and core network 112.

In some embodiments, the base station 108 may generate and transmit the configuration 130 to configure the UE 104 with one or more network slices, e.g., network slice 150. Each network slice (e.g., network slice 150) may be associated with a set of QoS or QoE parameters. For example, a network slice may be associated with a bit rate parameter, a latency parameter, or a reliability. These parameters may indicate a performance supported by the network slice. For example, if a bit rate parameter of a network slice has the value SB bits per second, then the slice may support an application that requires a bit rate of SB bits per second or less.

Each application may be associated with a set of QoS or QoE parameters. These parameters may indicate a minimum performance that is preferred to support the application. For example, the QoS or QoE parameters of the application may indicate a preferred bit rate, latency, bandwidth, or reliability. These parameters are determined to provide a QoS or QoE for the application. For example, a bit rate parameter of an application with the value AB bits per second may indicate that using a network slice that could support at least AB bits per second is preferred. Therefore, in assigning the application data traffic to a network slice, the UE 104 may compare one or more QoS or QoE parameters associated with the application or its data traffic against the QoS or QoE parameters associated with the slice 150. If the QoS or QoE parameters associated with the network slice 150 could support one or more QoS or QoE parameters of the application, then the UE may map the data traffic of the application to the network slice 150.

In some embodiments, each application may be associated with a category, e.g., file transfer, video streaming, mobile gaming, live multimedia streaming, web browsing, sports events, etc. In some cases, a slice may be pre-provisioned for a specific application. For example, a slice may be configured to carry data traffic associated with file transfer applications, or another slice may be configured to carry data traffic associated with mobile gaming applications. Such pre-provisioned configuration may not take into account UE capabilities or dynamic changes in the application server or UE state. It is advantageous to configure slices and assign data traffic to slices based on information provided by over-the-top (OTT) application operators associated with the application or application server or by the UE 104 associated with the UE preferences, capabilities, or conditions (e.g., one or more of remaining battery, network roaming preferences, billing preferences, or etc.).

Under certain circumstances, the end user may prefer to assign specific application data to a slice different from the network's pre-provisioned slices. For example, the user may prefer to use a slice with “better” QoS or QoE parameters (where “better” is respective to QoS or QoE parameters, e.g., higher bit rate, lower latency, higher bandwidth, higher reliability, etc.). In some embodiments, the UE 104 may generate and transmit report 140 to base station 108 to indicate its preferences in assigning applications to network slices. The base station 108 may receive and process report 140 and may send configuration 130 to configure new slices or reconfigure currently configured slices based on the information provided by the UE 104 in report 140.

In some embodiments, the UE 104 may use a single default interface for Internet access to a public network (e.g., external data network 120). The UE 104 may use dynamically activated Internet protocol (IP) interfaces for customized access to public networks (e.g., external data network 120). The UE 104 may also establish several interfaces for dedicated internal purposes, e.g., connection to network functions or private networks.

In some instances, the core network 112 may provide UE route selection policy(s) (URSP). The URSP may enable flexible separation of services and enhance traffic steering to improve QoE on a single device. The core network 112 may use the URSP rules to select a network slice among configured slices. However, it is advantageous to enable UE 104 to dynamically change the URSP policies, e.g., through the application server. For example, an interface between the application server and core network 112 (e.g., N33 interface between network exposure function and application function) may allow a dynamic change of URSP policies by the application server. The solution only provides coarse control on the selection of the pre-provisioned slices. Having on-demand, short-lived slices selected or configured by the UE 104 is advantageous.

In some embodiments, the UE 104 may perform an initial dynamic pairing of slice 150 with a packet data unit (PDU) session associated with the application data traffic. The initial pairing may be based on the QoS or QoE parameters of the application data traffic and the QoS or QoE parameters supported by the slice.

In some embodiments, the UE 104 may dynamically switch the data traffic to another slice based on changes in circumstances. For example, the UE 104 may switch the network slice in response to oscillating QoE, short service period for short-term slicing services, usage, lifespan, or pricing structure (e.g., need-based v. flat-fee), or availability of alternative or proxy slices (e.g., low latency wireless local area network (WLAN) personal hotspot mapping to cellular slices).

The UE 104 may trigger hierarchical initial slice selection based on its QoE and on-demand service needs. The UE 104 may trigger dynamic switching of an active slice to another pre-defined or pre-configured slice. In some embodiments, the UE 104 may trigger dynamic reconfiguration of an active slice. For example, the UE 104 may provide information on its preferred slice configuration to the base station 108 in report 140. The base station 108 may send configuration 130 to reconfigure the active slice based on report 140. In some embodiments, the UE 104 and an application server may trigger the reconfiguration of a pre-configured network slice.

In some embodiments, the UE 104 or the UE 104 and the application server may trigger changes in URSP. The UE 104 may configure or reconfigure URSP, policy update, or slicing assignment through an interface, e.g., an interface between UE and NEF. The interface may be a non-standardized application programming interface (API), or a standard interface, e.g., defined by the 3GPP Technical Specifications (TSs). The UE 104 may use the interface to exchange information with the application function (AF) to finalize the end-to-end slice selection or the QoE or QoS parameters of the application.

In an example, the network slice information 160 includes a configured NSSAI list 162, an allowed NSSAI list 164, a preferred NSSAI list 166, and user equipment route selection policy (URSRP) rules 168. Generally, NSSAI represents a set of information that assists in the selection and allocation of network slices for the UE 104. The NSSAI includes one or more single NSSAI (S-NSSAI) elements. Each S-NSSAI element includes a slice/service type (SST) indicating the type of the corresponding network slice (e.g., for eMBB, URLLC, mMTC, etc.).

Configured NSSAI can refer to a first set of S-NSSAI elements that have been configured for the UE 104. The configured NSSAI list 162 can include such a first set. Allowed NSSAI can refer to a second set of S-NSSAI elements that the UE 104 is permitted to use in a particular tracking area or network. The allowed NSSAI list 164 can include such a second set. The second set is typically a subset of the first set. Preferred NSSAI can refer to a third set of S-NSSAI elements that the UE 104 prefers to use and that may or may not have been configured and, if configured, have not been allowed. The preferred NSSAI list 136 can include such a third set. The third set is different from the first set and the second set and can, possibly, be a subset of the first set. The URSP rules 168 can specify how the UE 104 selects and uses different network slices for various applications and services.

The configured NSSAI list 162, the allowed NSSAI list 164, and the URSP rules 168 can be signaled by the network (e.g., by the core network 112 via the base station 108). In comparison, the preferred NSSAI list 166 can be proactively generated by the UE 104 (e.g., by an application processor thereof) based on potential network slicing needs of the UE 104. Before a network slicing need occurs, the UE 104 (e.g., the application processor and a baseband processor thereof) can register a network slice identified in the preferred NSSAI list 166 (referred to herein as a preferred network slice) with the network (e.g., with the core network 112). Upon such a registration, the network slice becomes allowed (referred to herein as an allowed network slice), whereby the allowed NSSAI list 164 is updated to identify the network slice, and whereby the preferred NSSAI list 166 is updated to no longer identify the network slice 164. To enable such flexibility, the URSP rule 168 need not identify a specific application that can use this network slice. Instead, a category of applications to which the application belongs can be identified.

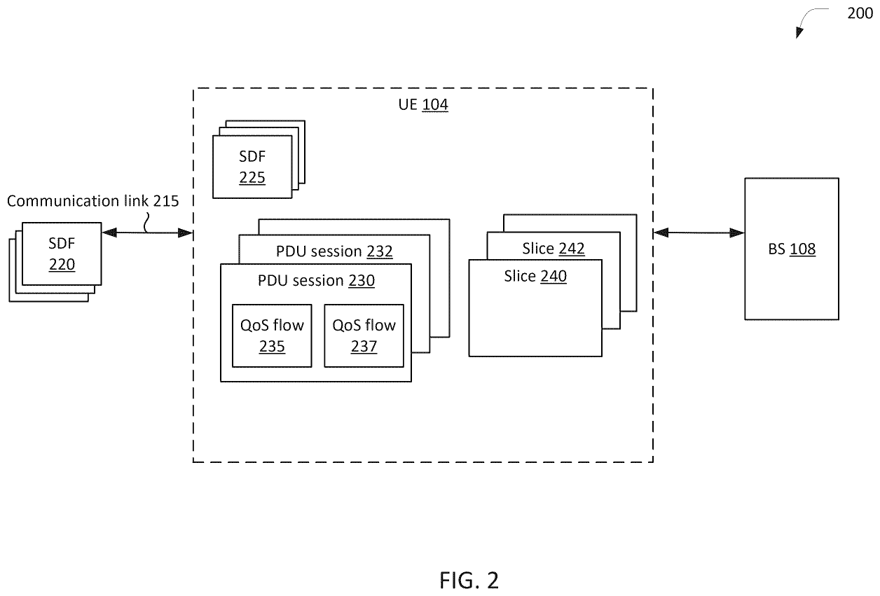

FIG. 2 illustrates a slicing diagram 200 in accordance with some embodiments. The slicing diagram 200 may include SDFs 220 and 225 mapped to a QoS flow (e.g., QoS flows 235 or 237) of a PDU session (e.g., PDU sessions 230 or 232). The PDU session may use the resources of a slice (e.g., slices 240 or 242) to transport the data traffic of the SDF to (or from) the base station 108.

When the UE 104 initiates a data transfer, the UE 104 may request the base station 108 to establish a PDU session, e.g., PDU session 230. Similarly, when the data is coming from the external network to the UE 104 for the first time, the base station 108 may configure the PDU session 230. The PDU session 230 may provide connectivity between the application at the UE 104 or the applications running on accessory devices connected to the UE 104 and the data network (DN), e.g., the external data network 120 in FIG. 1. In some instances, a PDU session may be associated with a radio bearer. The radio bearer may be a layer 2 (L2) logical channel that may provide a bi-directional logical channel between the UE 104 and the BS 108. The radio bearer that carries control signaling may be referred to as a signaling radio bearer (SRB). A radio bearer that carries user plane data or application data traffic is referred to as a data radio bearer (DRB).

The base station 108 may configure a default QoS flow when configuring a PDU session. A QoS flow may be associated with one or more QoS parameters that may define the performance provided by the QoS flow. A QoS flow may be configured with latency, guaranteed bit rate, bandwidth, or other parameters. For example, a QoS flow with a guaranteed bit rate parameter with a value of QB bits per second may provide (with high probability) a guaranteed bit rate of QB bits per second. The UE 104 may map an SDF, e.g., SDF 225, to a QoS flow, e.g., QoS flow 235, by comparing one or more QoS parameters of the SDF 225 with that of the QoS flow 235. If the QoS flow 235 could meet one or more QoS flow preferences of the SDF 225, then the UE 104 may map the SDF 225 to QoS flow 235. Otherwise, the UE 104 may compare one or more QoS parameters of the SDF 225 with that of the QoS flow 237. The UE 104 may continue the search until it matches the SDF 225 to one of the currently configured QoS flows, or the UE 104 may create an additional dedicated QoS flow with QoS parameters that match that of the SDF 225. The UE 104 may initiate the creation of the additional dedicated QoS flow to the base station 108 by sending a request to the base station 108. The base station 108 may create additional dedicated QoS flow using a policy control function (PDF).

In one embodiment, the UE may trigger hierarchical PDU-slice selection for an application. Initially, the UE 104 may receive data traffic from an SDF, e.g., SDFs 220 or 225. In some instances, the data traffic is generated by an application running on the same device as the UE 104, generating the SDF 225. In some instances, the data traffic is generated by an application running on an accessory that is connected to the UE 104 via communication link 215, generating the SDF 220. Consider that the UE 104 has received data traffic of SDF 225.

The UE 104 may dynamically select a PDU session, e.g., PDU session 230, that matches UE's initial QoE expectations or desired application or SDF category. In some instances, the UE 104 may select PDU session 230 based on mapping the SDF 230 to a QoS flow associated with the PDU session 230, e.g., QoS flow 235 or 237. For example, the UE 104 may determine that one or more QoS parameters of the SDF 225 is met by QoS flow 235 and accordingly may map the SDF 225 to QoS flow 235 of PDU session 230.

In some instances, a PDU session or a QoS flow of a PDU session may be associated with an application category or an SDF associated with such an application category. The UE 104 may select a PDU session or a QoS flow of the PDU session based on the category of the application or the category of the SDF. For example, a QoS flow 237 may be configured to support mobile gaming data traffic or applications. When the data traffic of SDF 225 is associated with mobile gaming, the UE 104 may map the SDF 225 to QoS flow 237 of PDU session 230.

Once the UE 104 selects the PDU session associated with the SDF, the UE may select the set of candidate slices that support the selected PDU. The UE 104 may determine the set of candidate slices by comparing one or more QoS or QoE parameters of the PDU session with that of the slice. If one or more QoS or QoE parameters of the PDU session are met by that of the slice, the UE 104 may include that slice in the set of candidate slices.

The UE 104 may reduce the number of candidate slices to identify or select a slice that meets the preferred QoS or QoE performance indicated by the QoS or QoE parameters of the SDF, application, associated QoS flow, or associated PDU session.

In some instances, the UE 104 may determine the QoS or QoE performance of an active or configured slice by monitoring its performance. The UE 104 may monitor the performance of active or configured slices by performing measurements. For example, the UE 104 may measure transmissions on an active slice. If the slice is not active, e.g., there is no transmission or data traffic on that slice, the UE 104 may configure periodic, semi-persistent, or aperiodic measurements. For example, the UE 104 may measure reference signal received power (RSRP), bitrate, latency, reliability, or other QoS or QoE parameters. The UE 104 may select a slice of the set of candidate slices based on the QoS or QoE performance monitoring.

In some instances, the UE 104 may select a slice of the candidate slices based on historical data, offline study, or training. For example, the UE 104 may use past measurements and monitoring data to create a profile of empirical data associated with the slice, e.g., data associated with QoS or QoE parameters of the slice.

In some instances, the UE 104 may select a slice based on a policy-based ordering of selected candidate slices. For example, the ordering may be based on satisfying PDU session 5G QoS identifier (5QI), guaranteed bit rate (GBR) or non-GBR parameter, or aggregated maximum bit rate (AMBR) parameter.

The UE 104 may consider other parameters in reducing the number of candidate slices or selecting the slice for transporting SDF. The UE 104 may consider UE pricing preferences, e.g., flat fee, or usage-period charge. For example, the UE 104 may prefer a slice with pricing based on usage-period and may remove the slices from the set of candidate slices with pricing other than usage-period charges. The UE 104 may select a slice with pricing based on usage-period charges.

In some embodiments, the UE 104 may consider the billing policy of the OTT servers, e.g., on-demand, usage-based, or flat-fee. For example, the OTT may prefer or require a billing policy, e.g., on-demand billing. The UE 104 may select a slice that meets the OTT servers' billing policy.

In some embodiments, the UE 104 may consider limitations on PDU session modification within a slice, e.g., the number of allowed PDU sessions in a slice or the number of allowed QoS flows in a PDU session or a slice. For example, the UE 104 may consider slices with a number of allowed PDU sessions greater than a threshold, the number of allowed QoS flows in a PDU session greater than a threshold, or the number of allowed QoS flows in the slice greater than a threshold. The UE 104 may consider the number of configured or activated PDU sessions in a slice or the number of configured or activated QoS flows in a PDU session or a slice. For example, the UE 104 may consider a slice if the difference between the number of allowed PDU sessions in that slice and the number of configured or activated sessions in that slice is greater than a threshold. In another instance, the UE 104 may consider a slice if the difference between the number of allowed QoS flows in a PDU session of the slice and the number of configured or activated QoS flows in that PDU of the slice is larger than a threshold.

In some embodiments, the UE 104 may consider the overhead of slicing management at the UE 104. UE 104 may consider coalescing across UE's applications or PDU sessions to reduce the overhead of slicing management, which may reduce the number of candidate slices in the set of candidate slices.

If the UE 104 is not able to select a slice in the set of candidate slices that supports the selected PDU session, the UE 104 may select a different PDU session that supports the SDF and repeat the procedure. The UE 104 may select the set of candidate slices that support the new PDU session and reduce the number of candidates as described above to find or select a slice that supports the PDU session and the SDF.

In some embodiments, the UE 104 may select a PDU session based on the QoS or QoE profile of the SDF and the URSP information, e.g., selecting a QoE-PDU session pair. Using the selected PDU session (or the QoE-PDU session pair), the UE 104 may select the set of slice candidates. The UE 104 may select a slice from the set of candidate slices, e.g., the QoE-PDU session-slice tuple. The UE 104 or the base station 108 may monitor dynamic QoE measurements, e.g., short-term service on/off requirements, of selected slices. The UE 104 may initiate on-demand slice configuration. The UE 104 may initiate the establishment of on-demand slice configuration by sending a request along with measurements, configuration information, or SDF QOS or QoE parameters to the base station 108. The base station 108 may acknowledge the establishment of on-demand slice configuration. Alternatively, if the base station 108 rejects the on-demand slice configuration, the UE 104 may select another slice from the set of candidate slices and initiate the establishment of the on-demand slice configuration. The UE 104 or the base station 108 may monitor billing policies, load changes, interrupting events, or other conditions that may trigger reconfiguration, reselections, or switching the slice.

When UE 104 detects a need for on-demand switching of previously selected slice-PDU session pair to another tuple or pair, the UE may trigger dynamic selection or switching of slice or PDU session. The UE 104 may detect a condition for on-demand switching when the UE 104 or network 108 detects a service change, e.g., due to overloading or a change in networking condition such as roaming, change in billing or charging policy.

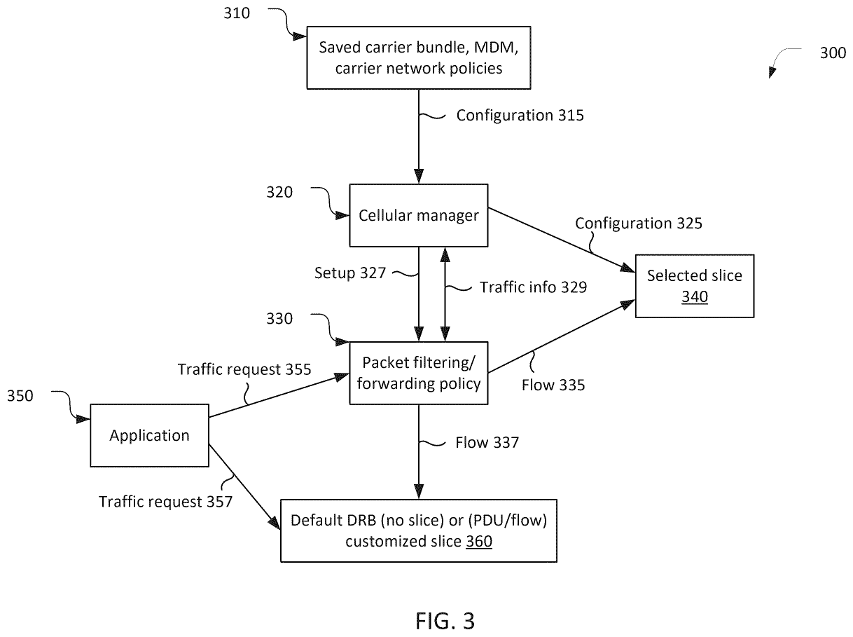

FIG. 3 illustrates an example solution 300 for slicing in accordance with some embodiments. Solution 300 includes operations for initial slice selection and on-demand slice switching. Solution 300 includes modules made of hardware logic, circuitry, or software to provide functionalities, signaling, and information exchanged among the modules.

Module 310 may provide storage for carrier bundles, mobile device management, or carrier network policies. Carrier network policies may include URSP, traffic category-based mapping of SDF to a traffic DRB, PDU session, or slice, or QoE-based mapping of SDF to a traffic DRB, PDU session, or slice. Module 310 may include non-volatile memory, e.g., non-volatile random access memory (NVRAM), flash memory, or subscriber identity module (SIM) card. Module 310 may provide configuration 315 to module 320.

Configuration 315 may include L2 configurations such as QoS flow, PDU session, slice, or measurement and reporting configurations. For example, configuration 315 may include RRC or other configurations of L2, e.g., radio link control (RLC), medium access control (MAC), or packet data convergence protocol (PDCP) sublayers.

Module 320 may be a cellular manager that provides L2 controller for data traffic. Module 320 may provide setup signaling 327 to module 330 and exchange traffic information 329 with module 330. Setup signaling 327 may include packet filtering and forwarding policy configurations and parameters for configuring the module 330. Traffic information may include empirical measurements, previously measured or trained data, or QoS or QoE parameters and characteristics of the data traffic. Module 320 may determine, select, configure, and activate the initial slice 340 based on the traffic information by configuration 325. After initial slice selection, module 320 may reconfigure slice 340 based on the UE 104 detection of a need for on-demand reconfiguration of the selected slice 340, e.g., detection of a change in network condition.

Module 330 may receive data traffic from application module 350 and apply filtering or traffic forwarding. The traffic forwarding or filtering may be applied at L2 based on slicing (e.g., URSP, slice-PDU pair mapped from application QoE) or DRB (e.g., in a default PDU session if no slice, or in a customized PDU session inside a slice). Module 330 may direct the data traffic to the activated slice, e.g., slice 340 or 360. In some embodiments, module 330 may dynamically select between the two configured slices 340 and 360. Module 330 may select from one or more of a pre-defined list of slices, e.g., slices 340 or 360, based on application traffic pattern, negotiation and signaling between UE 104 and base station 108, UE 104 performance expectation (e.g., QoE or QoS parameters) or monitoring, short-term billing requirement or service duration, or radio link or application state that is either predictively estimated or reactively monitored.

The filtering and traffic forwarding module 330 may forward the traffic request 350 to the selected slice 340 via flow 335. After the UE 104 detects a need to switch the active slice, the filtering and traffic forwarding module 330 may forward the traffic request 355 to the default or customized slice 360 via alternative flow 337.

Module 350 is the application module that generates the data traffic, e.g., the SDF. In some instances, when the traffic request is not subject to filtering or traffic forwarding policies, traffic request 357 may be sent directly to the default or customized slice 360.

In some embodiments, the UE 104 may trigger dynamic reconfiguration of configured PDU sessions within the existing slice based on UE's monitoring of real-time QoE, changing QoS flow, or application categories. In some instances, the PDU session modification is subject to core network 112 approval, e.g., based on URSP. The UE 104 may reconfigure a previously selected slice-PDU pair based on the detection of a need for on-demand reconfiguration, e.g., the detection of an overloading or networking condition.

In one embodiment, the UE 104 may reconfigure the initial selected slice 340 via configuration 325. The UE 104 may add, remove, or reconfigure QoS flow in a PDU session of an existing configured slice or URSP, e.g., a default DRB or customized slice 360.

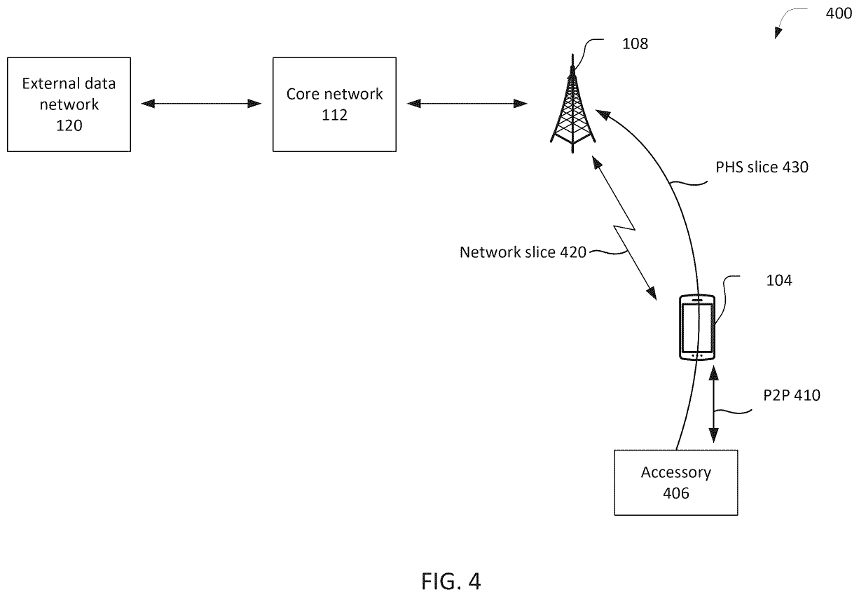

FIG. 4 illustrates a network environment 400 in accordance with some embodiments. Network environment 400 may be an example of network environment 100, including the UE 104, the base station 108, the core network 112, and the external data network 120. Network environment 400 may include accessory 406 connected to the UE 104 via peer-to-peer (P2P) link 410. In some instances, the P2P link 410 may be called a personal hotspot (PHS). The accessory device 406 may be head-mounted, and the P2P link 410 may be based on a WLAN neighbor-aware network (NAN), cellular, wireless personal area network (WPAN), ultra-wideband (UWB), or similar technologies. The application may run on accessory 406, and the application data traffic is relayed from the accessory 406 to the UE 104.

In some instances, base station 108 may configure network slice 420 between the UE 104 and base station 108. However, the selection of the slice may provide a PHS slice 430 that includes the P2P link 410. The QoS or QoE of PHS slice 430 may be an end-to-end QoS or QoE, including both P2P link 410 and the network slice 420. The PHS slice 430 may not be configured by base station 108, and base station 108 may only configure network slice 420. However, a network entity may consider the impact of the P2P link 410, e.g., reliability, latency, bandwidth, bit rate, etc., when selecting the network slice 420.

Solution 300, e.g., UE-triggered slice switching or UE-triggered slice reconfiguration, may be extended to network environment 400.

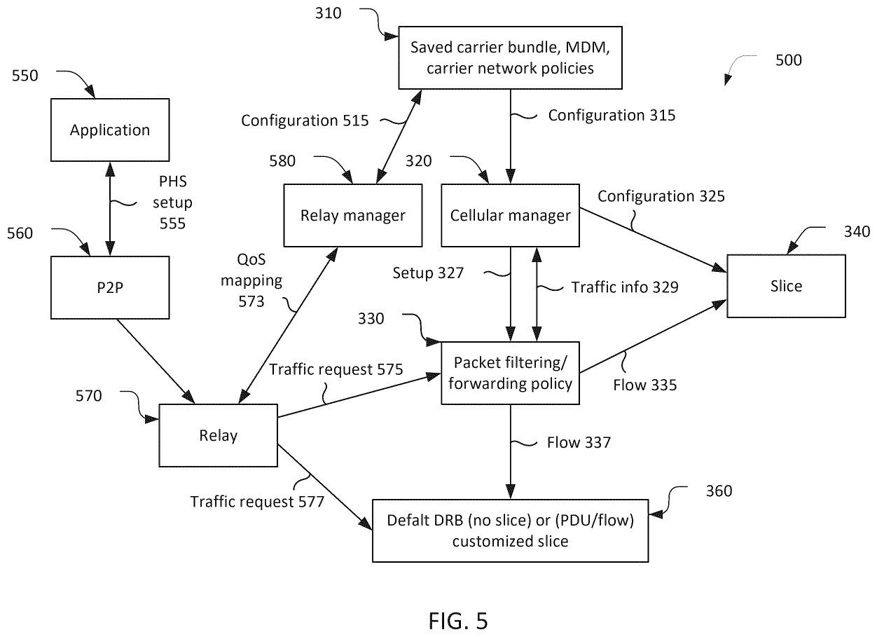

FIG. 5 illustrates an example solution 500 for slicing in accordance with some embodiments. Solution 500 is an example of UE-triggered dynamic slice selection of network slice, e.g., network slice 420 in FIG. 4, that may consider the internal congestion, loading information, radio link condition of the accessory device in selecting the slice, e.g., mapping of QoE or 5QI to PDU session and PDU session to slice. Any change or oscillation over the end-to-end path from the accessory device to the base station 108 may trigger dynamic slicing, as described above. Aspects of solution 500 may be similar to solution 300, in which the data traffic is relayed from the accessory device 406 to the UE 104. In solution 500, slice switching, or reconfiguration may be triggered by the accessory device 406 or may be triggered by the UE 104.

In some embodiments, the UE 104, or the accessory device 406 may trigger dynamic slice selection based on incoming PHS traffic or remote DL traffic from base station 108. In one embodiment, the slice selection may be performed at L2 (e.g., P2P-based) or layer 3 (L3), e.g., proxy-based. The modules, signaling, and operations common with solution 300 are described in the description of FIG. 3 above.

Solution 500 may include application 550. Application 550 is similar to application 350 in FIG. 3. Application 550 may run on the accessory device 406, whereas application 350 may run on the same device as the UE 104. Once the application generates data traffic, accessory device 406 may set up PHS using PHS setup signaling 555 to trigger the P2P module 560. The initial PHS setup may be configured based on the application's QoS or QoE parameters.

Solution 500 may include a P2P module 560, which may be part of the accessory device 406. P2P module 560 may provide an interface for transporting data traffic from the accessory device 406 to the relay module 570 of the UE 104.

Solution 500 may include a relay module 570. The relay module 570 may be on the same device as the UE 104. For example, the UE 104 may be the cellular circuitry on a device (e.g., a smartphone), and the relay module 570 may be the P2P circuitry on the same device (e.g., the same smartphone).

Solution 500 may include a relay manager 580. Relay manager 580 may perform functionalities similar to the cellular manager 320. The relay manager 580 manages the relay in accordance with the protocols associated with the relay or P2P technology, whereas the cellular manager 320 is based on the cellular technology and protocol stack. The QoS mapping 573 signaling may include information associated with mapping PHS to QoS flow. Module 310 may provide configuration 515, including the PHS mapping to QoS flow.

Once the PHS setup by the accessory device 406 is mapped to a QoS flow, solution 300 may be applied to determine the initial network slice 420, and UE-triggered slice switching, or slice reconfiguration may be applied to select a slice that supports the application data traffic.

In some embodiments, the information associated with the selected slice may be communicated with the accessory device 406. The accessory device 406 may update or reconfigure the PHS setup based on the selected slice. For example, if the selected slice can support a higher bit rate than the P2P link 410 of the PHS, the accessory device may reconfigure the P2P link 410 to increase the bit rate.

In some embodiments, the accessory device 406 or the relay module 570 may perform measurements to monitor the QoS or QoE parameters that the P2P link 410 can support.

The accessory device 406 or the UE 104 may trigger slice reselection or reconfiguration based on the measured parameters.

In some embodiments, if the slice selection operation cannot find a slice satisfying the QoS or QoE of the application data traffic, the accessory device may reconfigure the PHS slice or the P2P link 410.

In some embodiments, solution 500 provides L2 PHS to slice mapping. The relay module 570 and relay manager 580 perform L2 operations, and the QoS mapping 573 is an L2 mapping, e.g., mapping the data traffic to an L2 QoS flow. The relay module 570 may send traffic request 575 to packet filtering or forwarding policy module 330. Module 330 may forward the packet to the active slice. In case of switching slice from slice 340 to customized slice 360, the relay module 570 may send the traffic request 577 to the customized slice 360.

In some embodiments, solution 500 provides L3 PHS to slice mapping. The P2P module 560 may provide L3 proxy operation or L2 network extension control protocol (NECP). The relay manager 580 may also provide L3 proxy operations or L2 NECP. L3 proxy-based mapping may use L2 NECP rules to map the application data to slicing URSP. L2 NECP may scope traffic flows according to L3 traffic classes onto respective L2 P2P link and then onto a dynamically selected slice interface. If the slice selection solution provided in solution 3 cannot find a satisfying slice, the PHS slice setup may repeat to select a different P2P link 410.

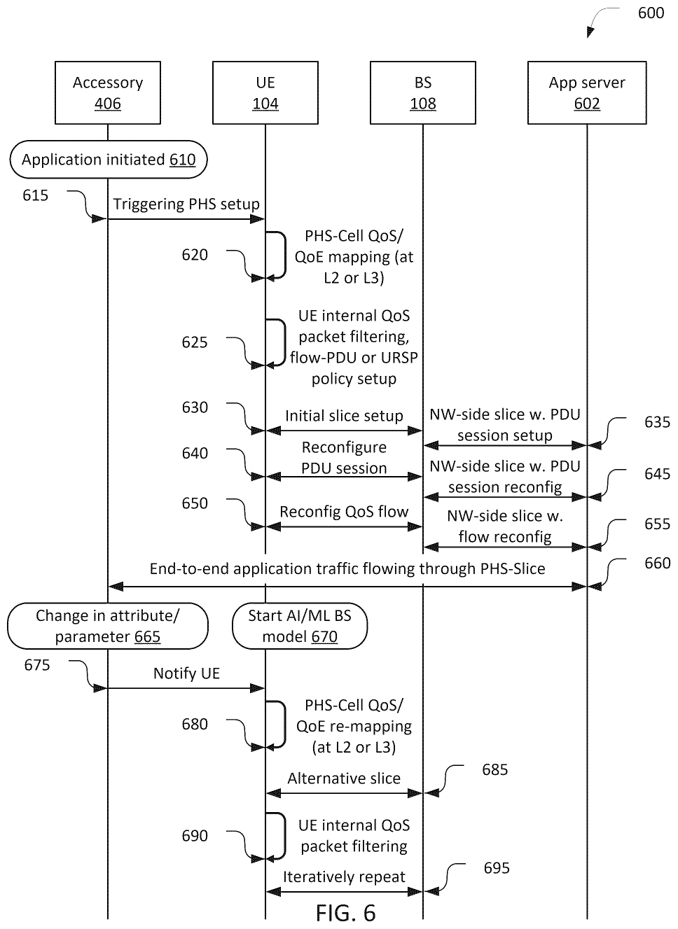

FIG. 6 illustrates a signaling diagram 600 in accordance with some embodiments. Signaling diagram 600 may describe the signaling or timing of solutions 300 and 500 as described above. Solution 600 may include application servicer 602. Application server 602 may be included in the external data network 120 in FIG. 1.

At 610, the application is initiated running on accessory 406 generating application data traffic. The application may be an example of application 350 in FIG. 3 or application 550 in FIG. 5.

At 615, the accessory device 406 may trigger PHS setup. The accessory device 406 may send a PHS setup request to the UE 104. The UE 104 may receive and process the PHS setup request from the accessory device 406.

At 620, the UE 104 may map the PHS to QoS or QoE, e.g., update the QoS or QoE of the application based on the parameters and configurations of the PHS or P2P link.

At 625, the UE 104 may configure its internal QoS packet filtering, QoS flow of PDU sessions, or URSP policies.

At 630, the UE 104 may set up the initial slice using the dynamic slice selection, e.g., as described in solution 500 in FIG. 5. The UE 104 may send information for the selected slice to the base station 108.

At 635, base station 108 may set up the selected slice and associate it with the PDU session of the application data traffic. Base station 108 may send information associated with the slice or the PDU session to the application server 602.

At 640, the UE 104 may detect or determine a condition for dynamic slice reconfiguration (e.g., detecting a change in networking condition). For example, the UE 104 may determine, based on monitoring and measurement, that the active slice does not meet the QoS, QoE, or other parameters (e.g., billing, pricing, etc.) of the application data traffic. The UE 104 may reconfigure the PDU session associated with the application data traffic.

At 645, base station 108 may reconfigure or update the slice associated with the application data traffic. Base station 108 may reconfigure the PDU session of the application data traffic. Base station 108 may send information of the reconfigured or updated slice or PDU session to the application server 602.

At 650, the UE 104 may detect or determine a condition for dynamic slice reconfiguration (e.g., detecting a change in networking condition). For example, the UE 104 may determine, based on monitoring and measurement, that the active slice does not meet the QoS, QoE, or other parameters (e.g., billing, pricing, etc.) of the application data traffic. The UE 104 may reconfigure the QoS flow associated with the application data traffic.

At 655, base station 108 may reconfigure or update the slice associated with the application data traffic. Base station 108 may reconfigure the PDU session of the application data traffic. Base station 108 may send information of the reconfigured or updated slice or QoS flow to the application server 602.

At 660, an end-to-end PHS slice is established between the accessory device 406 and application server 602.

At 665, the accessory 406 may detect a condition for switching, reconfiguring, or remapping the PHS slice. For example, the accessory 406 may determine, based on measurement or feedback from the UE 104 or base station 108, that the slice, the PDU session, or the QoS flow associated with the data traffic cannot meet the QoS, QoE, or other preference parameters of the application. Other preference parameters may include pricing or billing preferences. At 675, and in response to detecting the condition, accessory 406 may send a notification to the UE 104 to request or initiate a slice selection, reconfiguration, or switching operation.

At 670, and independent of accessory 406 detection of condition at 665, the UE 104 may monitor and measure the QoS or QoE parameters of the active slice and apply an BS-agreed AI/ML model to the measurement results for predicting another slice that may better meet the QoS/QoE requirements. Note that independently network-side (application server 602 or BS 108) may conduct similar behavior to find a “better” slice. When the UE 104 determines that the active slice cannot meet the QoS or QoE preferences of the application, the UE 104 may trigger operations to reselect, switch, or reconfigure the slice.

At 680, the UE 104 may remap the PHS (e.g., the P2P link 410 in FIG. 4) to QoS or QoE parameters. The UE 104 may adjust the QoS or QoE parameters of the application data traffic based on the PHS (e.g., P2P link 410). The remapping may be at L2 or L3 as described above. The UE 104 may iteratively search among slices of the set of candidate slices to select an alternative QoS flow or a different QoE. The alternative QoS flow may be associated with another slice. At 685, the UE 104 may notify base station 108 of switching to an alternative flow, PDU session or slice.

At 690, the UE 104 may map the PDU session or QoS flow to a slice of the set of candidate slices based on the packet filtering or the URSP policy. At 695, the UE 104 may monitor and measure the active slice's QoS, QoE, or other parameters. The UE 104 may iteratively repeat examining QoS or QoE mapping to QoS flow of a PDU session and mapping the PDU session in the same active slice or to a different slice.

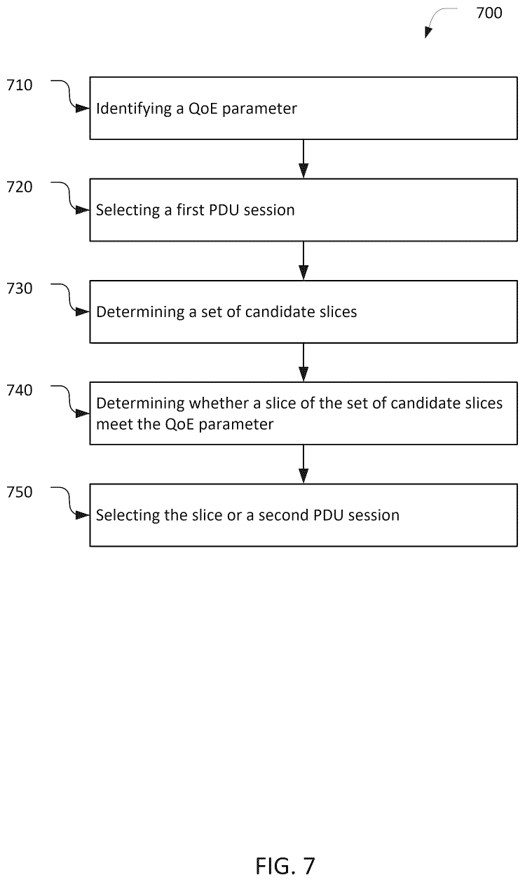

FIG. 7 illustrates an operation flow/algorithmic structure 700 in accordance with some embodiments. The operation flow/algorithmic structure 700 may be performed or implemented by a UE such as, for example, the UE 104 or UE 1800; or components thereof, for example, baseband processor circuitry 1804A.

The operation flow/algorithmic structure 700 may include, at 710, identifying a QoE parameter. The UE 104 may identify a QoE parameter of a data traffic. The QoE parameter may be prioritized over other QoE parameters. The prioritization may be configured, e.g., by the base station 108 through control signaling such as radio resource control (RRC) signaling. The prioritization may be defined in the 3GPP technical specifications (TSs). The QoE parameter may include one or more of the preferred bandwidth, bit rate, latency, or reliability. The QoE parameter may also include preferred pricing, billing policy, modification limitation, or overhead management parameters.

The operation flow/algorithmic structure 700 may include, at 720, selecting a PDU session. The UE 104 may select the PDU session based on the QoE parameter. For example, the UE 104 may determine a QoS flow that meets the QoE parameter of the data traffic and select the PDU session associated with the QoS flow.

The operation flow/algorithmic structure 700 may include, at 730, determining a set of candidate slices. The UE 104 may determine the candidate slices based on their association with the selected PDU session.

The operation flow/algorithmic structure 700 may include, at 740, determining whether a slice of the set of candidate slices meets the QoE parameter. The UE 104 may compare the QoE parameter of the data traffic with the QoE parameter of the QoS flow, the selected PDU session, or the candidate slice and determine whether the candidate slice can meet the QoE parameter of the data traffic.

The operation flow/algorithmic structure 700 may include, at 750, selecting the slice or another PDU session. If the UE 104 determines that the slice can meet the QoE parameter of the application data traffic, the UE 104 may select the candidate slice. The UE 104 may use the selected slice to transport the data traffic from the UE 104 to the base station 108.

If the UE 104 determines that the slice cannot meet the QoE parameter of the application data traffic, the UE may select another slice of the set of candidate slices. When all the slices of the set of candidate slices are exhausted without selecting a slice, the UE 104 may select another PDU session that meets the QoE parameter of the application data traffic.

In some embodiments, the UE 104 may select the slice of the set of candidate slices based on measurement associated with the QoE parameter, previously collected data, training data, or a pre-defined or configured order of the set of candidate slices.

In some embodiments, the UE 104 may determine that the slice meets the QoE parameter of the application data traffic. The UE 104 may detect a networking condition. Networking condition may include that the slice does not meet the QoE parameter of the application data traffic. Network condition may include determining that a measurement of the slice is smaller than a threshold or larger than a threshold. For example, the UE 104 may determine that the measured frame error rate or bit error rate is larger than a threshold; a measurement of the latency of the slice is larger than a threshold; or a measurement of bit rate is smaller than a threshold. Detection of network condition may include detecting a change in the traffic pattern or QoE parameter of the application data traffic. The change in QoE parameter may include a change in real-time QoE, a change in QoS flow, or a change in application category.

Detecting the network condition may trigger dynamic slice switching operation. The UE 104 may identify a configured PDU session based on the network condition. For example, when the network condition is a change in the QoE parameter, the PDU session is identified to meet the new QoE parameter or application data category.

The UE 104 may identify a configured slice associated with the identified PDU session and switch mapping the application data traffic from the currently active slice and PDU session to the identified PDU session and associated slice.

In some embodiments, the UE 104 may monitor a networking condition. The UE 104 may reconfigure the PDU session or the QoS flow associated with the PDU session based on the networking condition. The reconfiguration of the PDU session may include adding, removing, or reconfiguring a QoS flow associated with the PDU session where the application data traffic is mapped to the QoS flow.

In some embodiments, the application data traffic may run on an accessory device. The QoE parameter of the application data traffic may be mapped or adjusted based on a PHS or P2P link between the accessory device and the UE 104.

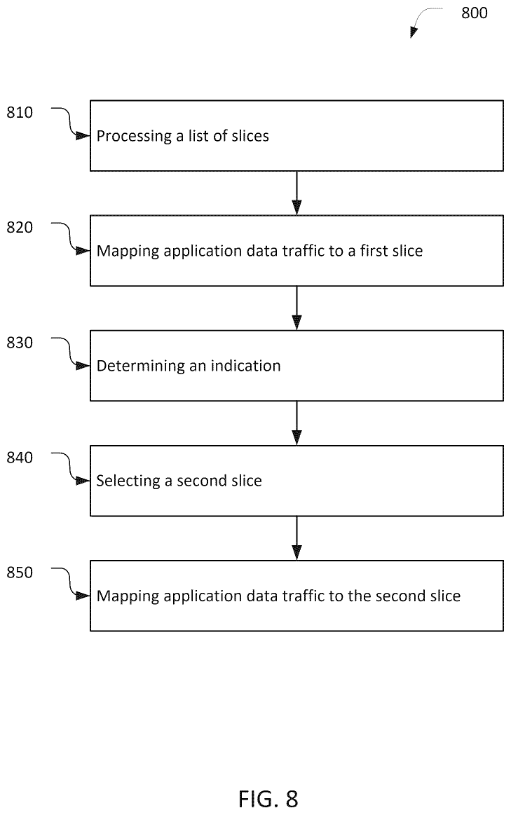

FIG. 8 illustrates an operation flow/algorithmic structure 800 in accordance with some embodiments. The operation flow/algorithmic structure 800 may be performed or implemented by a UE such as, for example, the UE 104 or UE 1800; or components thereof, for example, baseband processor circuitry 1804A.

The operation flow/algorithmic structure 800 may include, at 810, processing a list of slices. The UE 104 may be configured with one or more slices in a list of slices. For example, the base station 108 may configure one or more slices. RRC signaling or system information block may configure one or more slices.

The operation flow/algorithmic structure 800 may include, at 820, mapping application data traffic to a first slice from the list of configured slices. Mapping application data traffic to the slice may include mapping the application data traffic to a QoS flow, determining the PDU session associated with the QoS flow, and selecting a slice associated with the PDU session.

The operation flow/algorithmic structure 800 may include, at 830, determining an indication. The indication may include one or more changes in the application data traffic (e.g., a change of data traffic type or a change in the QoE of the application data traffic), a message received from the network (e.g., the base station 108), a QoE or QoS parameter associate with the application data traffic or the slice, a measurement associated with the performance of the slice, a short-term billing parameter, a service duration, a radio link condition, or an application state. In some instances, the indication may be monitored or estimated.

The operation flow/algorithmic structure 800 may include, at 840, selecting a second slice. The UE 104 may select a second slice from the list of configured slices based on the indication.

The operation flow/algorithmic structure 800 may include, at 850, mapping the application data traffic to the second slice. Mapping the application data traffic to the second slice may include mapping the application data traffic to a QoS flow associated with the second slice.

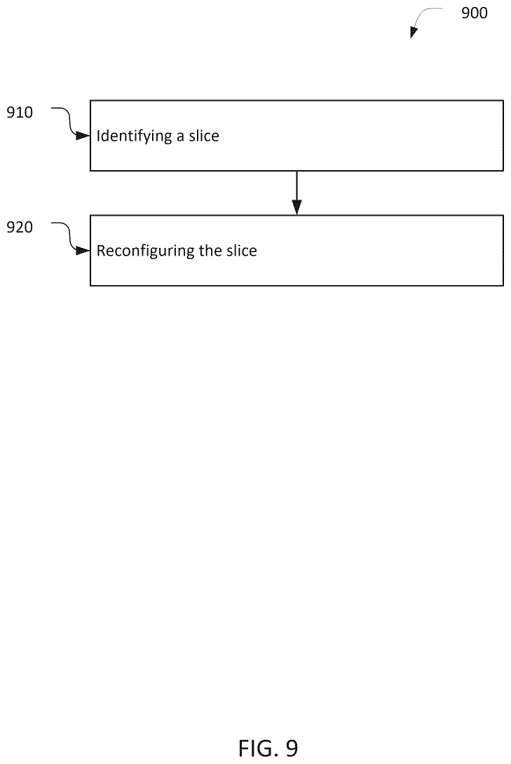

FIG. 9 illustrates an operation flow/algorithmic structure 900 in accordance with some embodiments. The operation flow/algorithmic structure 900 may be performed or implemented by a UE such as, for example, the UE 104 or UE 1800; or components thereof, for example, baseband processor circuitry 1804A.

The operation flow/algorithmic structure 900 may include, at 910, identifying a slice. The UE 104 may identify the active slice.

The operation flow/algorithmic structure 900 may include, at 920, reconfiguring the slice based on an indication. Reconfiguring the slice may include reconfiguring a PDU session or a QoS flow associated with the slice. The indication may be associated with one or more of application traffic (e.g., an indication of a change in application data traffic type), a message received from the network (e.g., the base station 108), a QoE or QoS parameter, a measurement, a short-term billing parameter, a service duration, a radio link condition, or an application state.

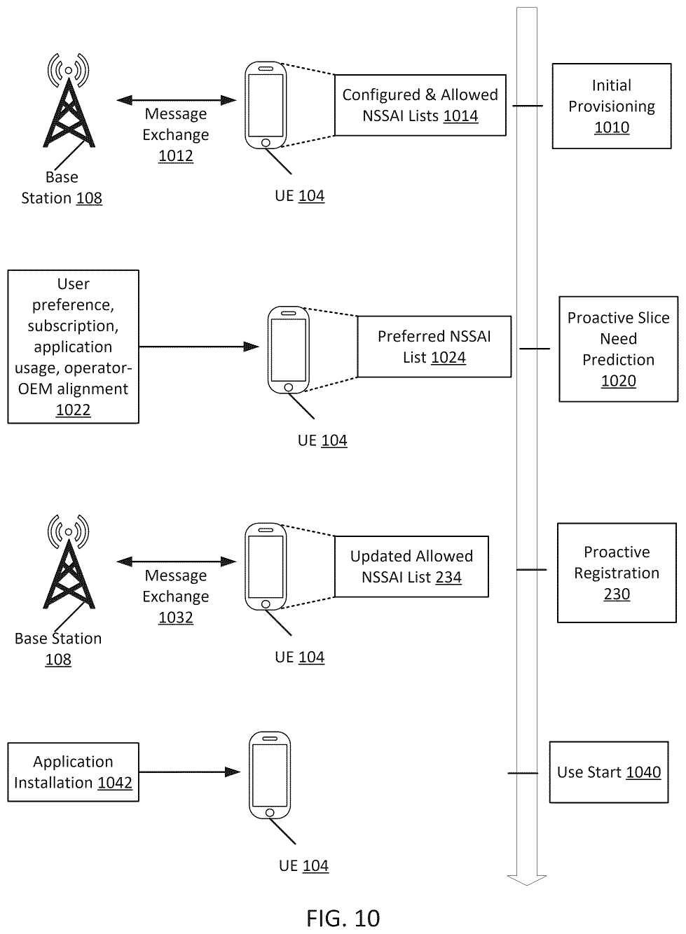

A FIG. 10 illustrates an example of proactively enabling a network slice, in accordance with some embodiments. The illustrated example shows multiple stages for the enabling the network slice: initial provisioning 1010, proactive slice need prediction 1020, proactive registration 1030, and use start 1040. Each of these phases is described herein below. Generally, a network (e.g., via a base station 108, which an example of the base station 108) can configure and allow multiple network slices for a UE 104 (e.g., an example of the UE 104). The UE 104 can also determine that the allowed network slices and/or the configured network slices may not satisfy a potential network slice need thereof. Accordingly, the UE 104 maintains information about preferred network slices (that are not configured or, if configured, not allowed) and proactively completes a registration with the network (e.g., via the base station 108) that at least one of these preferred network slices is configured (if not previously configured) and allowed for the UE 104.

During the initial provisioning 1010, the UE 104 and the base station 108 complete a message exchange 1012 (e.g., involving mobility registration requests and mobility registrations accepts), such that a first set of network slices is configured for the UE 104 and a second set of network slices (e.g., a subset of the first set) is allowed for the UE 104. For example, when the UE 104 attaches to the network or initiates a session, it can include NSSAI in signaling messages to indicate its network slice requirements. The AMF of the network uses the NSSAI, among other information (e.g., subscription information of the UE 104, network load, etc.), to select the appropriate network slice(s) that match the UE's requirements and can allow a subset of the network slices(s). An example of the initial provisioning 1001 is described in 3GPP technical specification (TS) 24.501, V 18.7.0 (2024 Jul. 12), the content of which is incorporated herein by reference in its entirety. The UE 104 can store configured and allowed NSSAI lists 1014 (e.g., corresponding to the configured NSSAI list 132 and the allowed NSSAI list 134 of FIG. 1). The number of configured network slices can be limited to a first maximum (e.g., sixteen). Likewise, the number of allowed network slices can be limited to a second maximum (e.g., eight), smaller than or equal to the first maximum.

During the proactive slice need prediction 1020, the UE 104 determines that a network slice is preferred, where this network slice is not included in the allowed network slices or the configured network slices. This determination can be proactively performed before an actual network for the network slice occurs. For example, before an application is installed on the UE 104, the UE 104 can determine that a network slice is needed to support the application when installed (or a category of applications to which the application belongs). Different techniques and a combination of such techniques is possible to determine the need and can rely on information relating to a user preference, the subscription, application usage, and/or an operator-original equipment manufacturer (OEM) alignment 1022. Such techniques can be implemented on an application processor of the UE 104.

One example technique relies on the user preference. The user preference can be explicit, whereby user input can be received requesting a purchase, a download, a social media following or liking, or a queuing of the application. The user preference may additionally or alternatively be implicit. For instance, one or more applications may already be installed on the UE 104. The already installed application(s) can belong to a category of applications. Because one or more applications of the category have been installed, the UE 104 can determine that any other uninstalled application of the category can be of interest. In the explicit user preference situation, the UE 104 can determine that a network slice is preferred specifically for the uninstalled application. In the explicit and implicit user preference situations, the UE 104 can determine that a network slice is preferred specifically for the category.

Another example technique relies on the subscription. The subscription can indicate a service to which the UE is subscribed. If the service is specific to an application (uninstalled or installed on the UE 104), the UE 104 can determine that a network slice is preferred specifically for the uninstalled application. If the service is specific to a category of applications, the UE 104 can determine that a network slice is preferred specifically for the category.

Yet another example technique relies on the application usage. Here, the usage can be specific to one or more applications installed on the UE 104 and used over a predefined time period (e.g., the last month). If the usage indicates a use rate over a predefined threshold (e.g., used more than ten times in the last month), the UE 104 can determine that a network slice is preferred for a category of applications to which the one or more applications belong.

A further example technique relies on the operator-OEM alignment. Here, the network can be operated by an operator, whereas the UE 104 can be available from an OEM. The operator and OEM can enter into an agreement such that service of the network can be made available to an application installable on the UE 104. The UE 104 can receive an indication from the network about such availability. The application need not already be installed on the UE 104. The UE 104 can determine that a network slice is preferred for the application or for a category of applications to which the application belongs.

Additionally or alternatively, the UE 104 (e.g., its application processor) can execute an artificial intelligence (AI) model trained to predict a preferred network slice, an application for which the preferred network slice is needed, and/or a category of applications to which the application belongs. The AI model can be a machine learning (ML) model (which can be referred to as an AI-ML model or as an ML model). The input to the AI model can include any or a combination of the above information about the user preference, the subscription, application usage, and/or operator-OEM alignment 1022. The input can additionally or alternatively include other factors that may relate to the UE 104, the network, and/or access of the UE 104 to the network, such as a time of day, a location of the UE, a network connectivity status (e.g., whether the UE 104 is connected to a WiFi network), etc.

Before declaring such a slice to be preferred, the UE 104 can check the configured and allowed NSSAI lists 1014 to determine whether it is identified in such lists 1014. If not, the network slice can be declared as preferred. Otherwise, no such declaration is made.

The above techniques are described in relation to determining a preferred network slice. Alternatively, or additionally, the techniques can be used to determine a preferred application (e.g., one that has not been installed yet on the UE 104) and/or a category of applications (e.g., for which no applications has not been installed yet on the UE 104; however, it may be possible that one or more applications that belong to the category are already installed on the UE 104). In this case, the UE 104 can determine that a network slice is needed and check the configured and allowed NSSAI lists 1014 before declaring the network slice as a preferred network slice. Alternatively, or additionally, the UE 104 can check its URSP rules (e.g., URSP rules 138) to see if the application and/or the category is identified. If so, the UE 104 can declare the network slice as preferred. Otherwise, no such declaration is made.

In an example, a URSP rule need not identify a specific application. Instead, the URSP rule can identify a category of applications to which the application belongs. To illustrate, say that the application's identifier is “XYZ” and this application belongs to a “gaming” category. The URSP rule need not include the “gaming” category and the “XYZ” application identifier. Instead, the URSP rule can include only the “gaming” category or an indication that this rule applies to all applications belonging to this category (e.g., the indication can be set as “*.Games,” whereby “*” indicates that all traffic of gaming application can use one or more slices associated with the URSP rule). In this way, the enabling of a new slice can be more dynamic and may not need an updated URSP rule.

Upon determining a set of preferred network slices (or equivalently, a preferred set of applications or a preferred set of application categories), the UE 104 (e.g., its application processor) can prioritize the elements of the set. This may be needed depending on the first maximum number of configured network slices, the actual number of configured network slices, the second maximum number of allowed network slices, and the actual number of allowed network slices. For instance, say that the maximum number of configured network slices is sixteen, the actual number of configured network slices is ten, the second maximum number of allowed network slices is eight, and the actual number of allowed network slices is six. Say also the set includes seven elements. None of the seven preferred network slices has been configured. Because ten configured network slices already exist and the maximum is sixteen, the UE 104 can rank the seven elements in a priority order and determine that the least ranked element can be removed from the set. As such, a set of six elements remain. Next, because six allowed network slices already exist and the maximum is eight, the UE 104 can retain the top two ranked elements and remove the remaining four from the set, resulting in a set of two. This set is now the preferred set.

In this way, the UE 104 can prioritize the network slices that align with the current application installation. If the number of preferred application categories exceed the second maximum number, priority can be given to the applications that are more frequently used by over less frequently used applications.

Different techniques can be used for the prioritization. One example technique can involve a likelihood of use, which may be indicated by any of the above techniques used for determining that a network slice (or an application or an application category) is preferred. In another example technique, the AI model itself can output the priority.

As a result of the proactive slice need prediction 1020, the UE 104 can generate and store a preferred NSSAI list 1024 (e.g., the NSSAI list 136 of FIG. 1). This list 1024 can identify a network slice and can associate the network slice with an application category (and, possibly, with a specific application).

During the proactive registration process 1030, the UE 104 (e.g., its application processor and baseband processor) can register one or more of the preferred network slices with the network. An example of this registration is further described below, and its use can depend on a set of conditions being satisfied. Generally, for an uninstalled application, the UE can register a preferred network slice before the application is installed on the UE 104. For an already installed application, the UE can register a preferred network slice before the application is launched on the UE 104. The registration can be triggered based on the preferred NSSAI list 1024 being generated or updated and/or an update by the network to the configured NSSAI list.

The registration involves the UE 104 and the base station 108 completing a message exchange 1032 (e.g., involving mobility registration request(s) and mobility registrations accept(s)), such that the network indicates, to the UE 104, that a preferred network slice is allowed. Upon such an indication, the UE 104 (e.g., its baseband processor) can update the allowed NSSAI list to identify this network slice, resulting in an updated NSSAI list 1034.

During the use start 1040, the UE 104 can start using the previously preferred now allowed network slice. Here, a previously uninstalled application is installed and launched, or a previously installed application is launched. Upon the launch, a PDU session over the network slice can be established with the network. Further, the UE 104 (e.g., its application processor) can check URSP rules to determine how to route traffic of the launched application. As explained herein above, the URSP rules may not specifically identify the application and, instead, may identify the application category to which the application belongs. In this case, the application processor can determine a match between the category of the application and a URSP rule and can use the URSP rule to determine that the traffic is to be routed over the network slice.

In a particular example of this URSP look-up, the application process can compare entries in an application store and/or entitlement categories against encoded application identifiers received in URSP rules to determine the list of supported URSP rules. An application identifier can be encoded with the application category rather than a specific application identifier (e.g., encoded as “*. Games” for a gaming category where “*” means all traffic of gaming applications can use allowed network slices if there is a gaming application installed on the UE 104). By looking up the relevant entitlement category, the application processor can identify the applicable URSP rule.

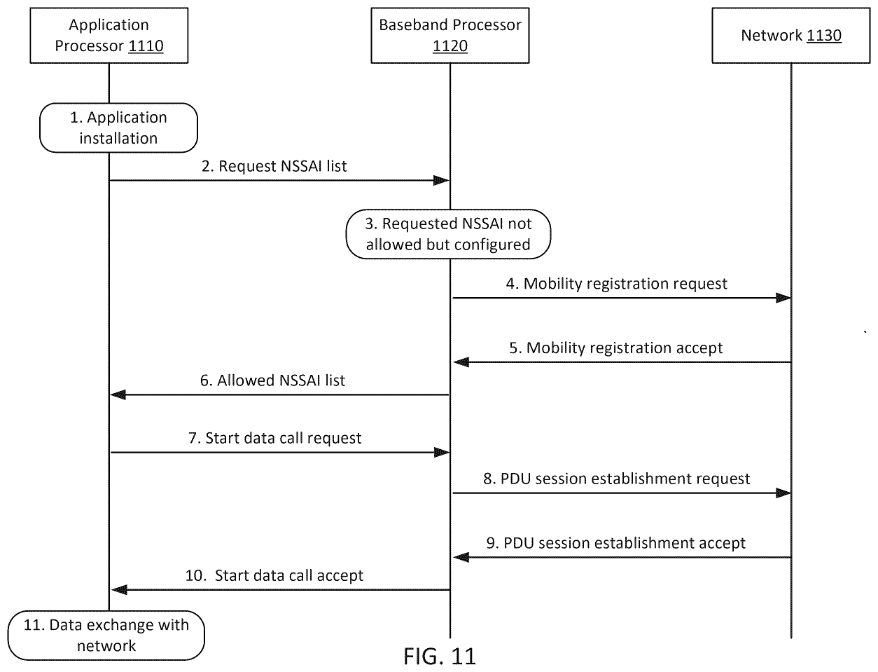

FIG. 11 illustrates an example of a sequence diagram for enabling a network slice, in accordance with some embodiments. The sequence diagram involves an application processor 1110 of a UE (e.g., the UE 104), a baseband processor 1120 of the UE, and a network 1130 (e.g., including the RAN 110 and the core network 112). The sequence diagram can be performed during the initial provisioning 1010 of FIG. 10.

In a first step of the sequence diagram, the application processor 1110 installs an application. This application uses a specific network slice (e.g., S-NSSAI_10 for illustrative purposes). Upon the application installation, in a second step of the sequence diagram, the application processor 1110 can request the network slice to be used by informing the baseband processor 1120 about it (e.g., using a message exchange for a requested NSSAI list that includes S-NSSAI_10).

In a third step of the sequence diagram, the baseband processor 1120 determines that the requested network slice is not allowed but is configured. For example, the baseband processor 1120 determines that S-NSSAI_10 is not part of the allowed NSSAI but is part of the configured NSSAI. As a result, in a fourth step of the sequence diagram, the baseband processor 1120 sends a mobility registration request to the network 1130 (e.g., via the base station 108). The mobility registration request can indicate requested NSSAI that includes S-NSSAI_10. Upon processing this request (e.g., by authenticating it, checking the subscription related to the UE and other parameters), in a fifth step of the sequence diagram, the network 1130 can return a mobility registration accept. This response can indicate that allowed NSSAI includes S-NSSAI_10.

In a sixth step of the sequence diagram, the baseband processor 1120 indicates to the application processor 1110 that the requested network slice is now allowed. For example, the baseband processor 1120 returns an allowed NSSAI list that includes S-NSSAI_10.

In turn, and in a seventh step of the sequence diagram, the application processor 1110 initiates the use of the network slice. As illustrated, the application processor 1110 starts a data call request to the baseband processor 1120, where this request includes S-NSSAI_10.

In an eighth step of the sequence diagram, the baseband processor 1120 sends a PDU session establishment request to the network. This request identifies the network slice (e.g., includes S-NSSAI_10). Upon processing this request (e.g., by authenticating it, checking the subscription related to the UE and other parameters), in a nineth step of the sequence diagram, the network 1130 can return a PDU session establishment accept. This response can indicate that the PDU session is to use the network slice (e.g., the response includes S-NSSAI_10).

In a tenth step of the sequence diagram, the baseband processor 1120 indicates to the application processor 1110 that the call request is accepted. For example, the baseband processor 1120 returns a start call data accept message that includes S-NSSAI_10. In an eleventh step, the application processor 1110 can exchange data with the network. The exchange can rely on the applicable URSP rule, indicating that the routing needs to occur over the network slice. The routing can be via the baseband processor 1120.

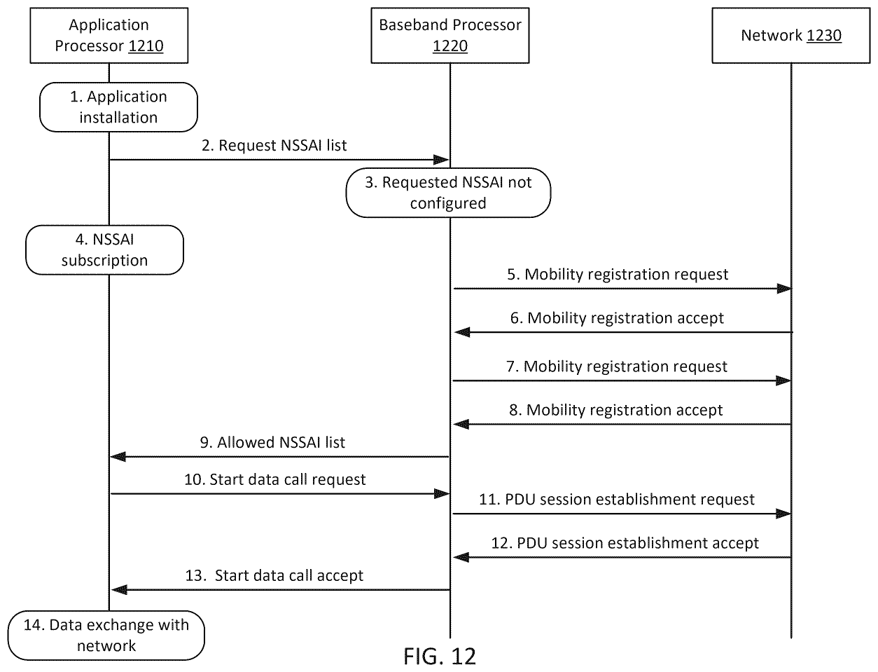

FIG. 12 illustrates another example of a sequence diagram for enabling a network slice, in accordance with some embodiments. The sequence diagram can be similar to that of FIG. 11, except that a requested network slice is not part of the configured network slices (e.g., is unidentified in a configured NSSAI list). Here also, the sequence diagram involves an application processor 1210 of a UE (e.g., the UE 104), a baseband processor 1220 of the UE, and a network 1230 (e.g., including the RAN 110 and the core network 112). The sequence diagram can be performed during the initial provisioning 1010 of FIG. 10.

In a first step of the sequence diagram, the application processor 1210 installs an application. This application uses a specific network slice (e.g., S-NSSAI_10 for illustrative purposes). Upon the application installation, in a second step of the sequence diagram, the application processor 1210 can request the network slice to be used by informing the baseband processor 1220 about it (e.g., using a message exchange for a requested NSSAI list that includes S-NSSAI_10).

In a third step of the sequence diagram, the baseband processor 1220 determines that the requested network slice is not configured. For example, the baseband processor 1220 determines that S-NSSAI_10 is not identified in a configured NSSAI list. As a result, the baseband processor 1220 foregoes at this time from enabling the network slice.

In a fourth step of the sequence diagram, a subscription of the UE with the network 1230 is updated. This update indicates that the network slice is now subscribed (or a related service is subscribed). It may be possible that the subscription is completed via a user interface of the UE and can rely on a function executed by the application processor 1210. If so, the application processor determines that the subscription has occurred (e.g., S-NSSAI_10 is now supported by the subscription). Nonetheless, such a determination may not be needed.

In a fifth step of the sequence diagram, the baseband processor 1220 sends a mobility registration request to the network 1220. This request can be initiated due to any trigger (e.g., an RRC connection, reconnection, handover, etc.). Further, this request need not identify the network slice (e.g., need not include S-NSSAI_10). In response, and in a sixth step of the sequence diagram, the network 1230 can return a mobility registration accept message. Because the network slice has been subscribed to, this response can indicate that new configured NSSAI includes S-NSSAI_10. As such, the baseband processor 1220 updates its stored configured NSSAI to include S-NSSAI_10.

Because this network slice is now configured and was previously requested by the application processor 1210, in a seventh step of the sequence diagram, the baseband processor 1220 sends a mobility registration request to the network 1230 (e.g., via the base station 108). The mobility registration request can indicate requested NSSAI that includes S-NSSAI_10. Upon processing this request (e.g., by authenticating it, checking the subscription related to the UE and other parameters), in an eighth step of the sequence diagram, the network 1230 can return a mobility registration accept. This response can indicate that allowed NSSAI includes S-NSSAI_10.

In a nineth step of the sequence diagram, the baseband processor 1220 indicates to the application processor 1210 that the requested network slice is now allowed. For example, the baseband processor 1220 returns an allowed NSSAI list that includes S-NSSAI_10.

In turn, and in a tenth step of the sequence diagram, the application processor 1210 initiates the use of the network slice. As illustrated, the application processor 1210 starts a data call request to the baseband processor 1220, where this request includes S-NSSAI_10.

In an eleventh step of the sequence diagram, the baseband processor 1220 sends a PDU session establishment request to the network. This request identifies the network slice (e.g., includes S-NSSAI_10). Upon processing this request (e.g., by authenticating it, checking the subscription related to the UE and other parameters), in a twelfth step of the sequence diagram, the network 1230 can return a PDU session establishment accept. This response can indicate that the PDU session is to use the network slice (e.g., the response includes S-NSSAI_10).

In a thirteenth step of the sequence diagram, the baseband processor 1220 indicates to the application processor 1210 that the call request is accepted. For example, the baseband processor 1220 returns a start call data accept message that includes S-NSSAI_10. In a fourteenth step, the application processor 1210 can exchange data with the network. The exchange can rely on the applicable URSP rule, indicating that the routing needs to occur over the network slice. The routing can be via the baseband processor 1220.

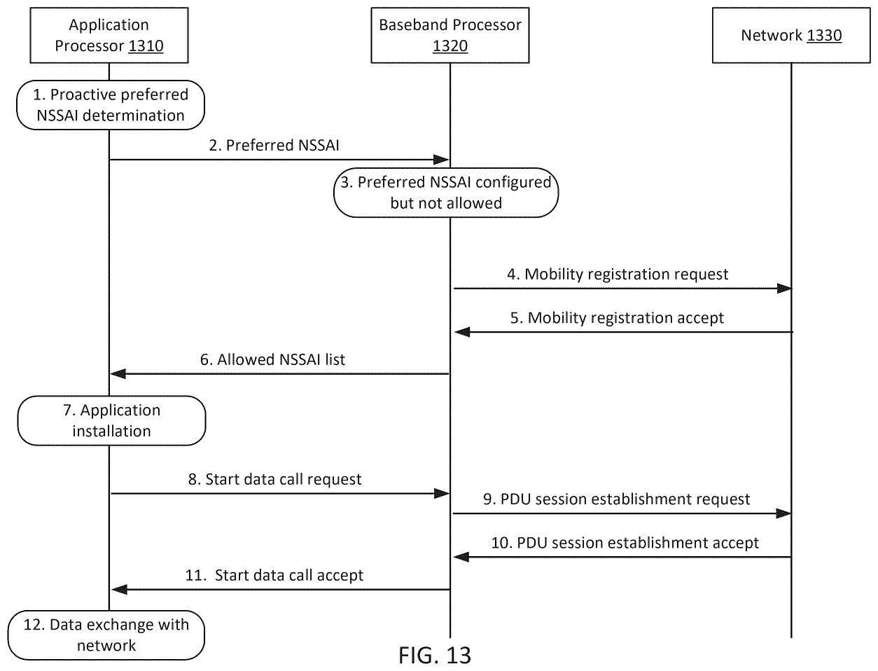

FIG. 13 illustrates an example of a sequence diagram for proactively enabling a network slice, in accordance with some embodiments. The sequence diagram involves an application processor 1310 of a UE (e.g., the UE 104), a baseband processor 1320 of the UE, and a network 1330 (e.g., including the RAN 110 and the core network 112). The sequence diagram can be performed during the proactive slice need prediction 1020 and proactive registration 1030 of FIG. 10.

In a first step of the sequence diagram, the application processor 1310 proactively determines preferred NSSAI indicating preferred network slices (or, equivalently, proactively determines a preferred application (e.g., an uninstalled application or an unlaunched application) or an application category, each of which can be associated with an NSSAI). The application processor 1310 can check the preferred NSSAI against allowed NSSAI (and/or application categories in the preferred NSSAI against URSP rules) and determines that no match exists between allowed network slices and the preferred network slices (or between already supported applications or application categories and preferred applications or preferred application categories).

In a second step of the sequence diagram, the application processor 1310 notifies the baseband processor of the preferred NSSAI (or the preferred application or preferred application category). For instance, the application processor 1310 sends a request to the baseband processor that identifies a preferred network slice (e.g., S_NSSAI_20 for the sake of example; or that identifies the preferred application or preferred application category), where this request can trigger a registration of the preferred network slice.

In a third step of the sequence diagram, the baseband processor 1320 determines that the requested network slice is configured but not allowed. For example, the baseband processor 1320 determines that S-NSSAI_20 is identified in a configured NSSAI list but not on an allowed NSSAI list. If the preferred application or preferred application category are identified to the baseband processor 1320 instead of the preferred network slice, the baseband processor 1320 can determine this slice based on preferred application or preferred application category.

As a result, in a fourth step of the sequence diagram, the baseband processor 1320 sends a mobility registration request to the network 1330 (e.g., via the base station 108). The mobility registration request can indicate the preferred NSSAI that includes S-NSSAI_20.

In an example, the baseband 1320 determines whether a set of conditions is met prior to sending the mobility registration request. If satisfied, this request is sent. Otherwise, the request is not sent. Different conditions may be checked.

In one example, the set of conditions relates to the allowed NSSAI. For instance, the set of conditions is satisfied upon a determination that the allowed NSSAI list includes one or more single NSSAIs (S-NSSAIs) absent from the preferred NSSAI list. To illustrate, if this set is satisfied if not all the network slices that the UE is currently registered to match the network slices that are requested by application processor 610 (e.g., as preferred network slices).

In one example, the set of conditions relates to the length of allowed NSSAI (e.g., the number network slices are already allowed). For instance, the set of conditions is satisfied upon a determination that a length of the allowed NSSAI list is smaller than a maximum length (e.g., less than eight). Particularly, say this maximum is eight and the number already allowed network slices is sixth, then the UE can request two preferred network slices to be allowed.

In one example, the set of conditions relates to the operational mode of the UE (e.g., the baseband processor 620). The UE can operate in a radio resource control (RRC) connected mode, an RRC idle mode, or an RRC inactive mode. The set of conditions is satisfied upon a determination that the UE is operating in the RRC idle mode.

In one example, the set of conditions relates to the configured NSSAI. For instance, the set of conditions is satisfied upon a determination that the preferred NSSAI list includes a single NSSAI (S-NSSAI) absent from a configured NSSAI list. To illustrate, if a network slice that was previously indicated as preferred is now part of a subscribed NSSAI list and is no longer part of a rejected NSSAI list, then the set of conditions is satisfied.

Upon processing the mobility registration request (e.g., by authenticating it, checking the subscription related to the UE and other parameters), in a fifth step of the sequence diagram, the network 1330 can return a mobility registration accept. This response can indicate that allowed NSSAI includes S-NSSAI_20.

In a sixth step of the sequence diagram, the baseband processor 1320 indicates to the application processor 1310 that the preferred network slice is now allowed. For example, the baseband processor 1320 returns an allowed NSSAI list that includes S-NSSAI_20.

The above sixth steps occur before an application that would use this allowed network slice (e.g., S-NSSAI_20) is installed (or launched). Particularly, above steps of the sequence diagram performed by the UE reflect the fact that the UE proactively registers the preferred network slice.

In a seventh step of the sequence diagram, the application processor 1310 installs the application. This application uses a specific network slice (e.g., S-NSSAI_20). Upon the application installation (or being launched), in an eighth step of the sequence diagram, the application processor 1310 initiates the use of the network slice. As illustrated, the application processor 1310 starts a data call request to the baseband processor 1320, where this request includes S-NSSAI_20.

In a nineth step of the sequence diagram, the baseband processor 1320 sends a PDU session establishment request to the network. This request identifies the network slice (e.g., includes S-NSSAI_20). Upon processing this request (e.g., by authenticating it, checking the subscription related to the UE and other parameters), in a tenth step of the sequence diagram, the network 1330 can return a PDU session establishment accept. This response can indicate that the PDU session is to use the network slice (e.g., the response includes S-NSSAI_20).

In an eleventh step of the sequence diagram, the baseband processor 1320 indicates to the application processor 1310 that the call request is accepted. For example, the baseband processor 1320 returns a start call data accept message that includes S-NSSAI_20. In a twelfth step, the application processor 1310 can exchange data with the network. The exchange can rely on the applicable URSP rule indicating that the routing needs to occur over the network slice. The URSP rule can be looked up by using the application category of the application rather than its identifier. The routing can be via the baseband processor 1320.

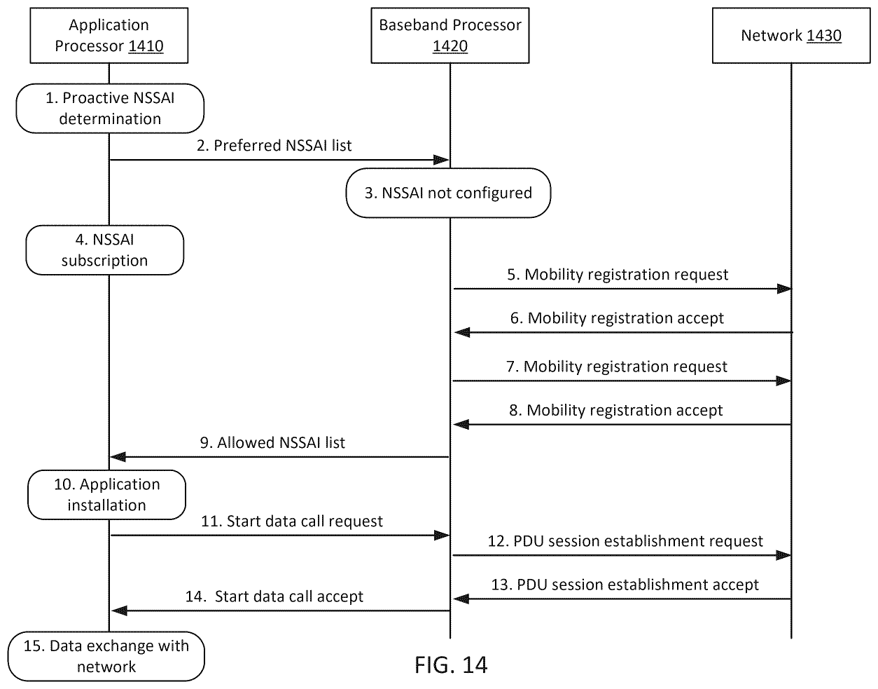

FIG. 14 illustrates another example of a sequence diagram for proactively enabling a network slice, in accordance with some embodiments. The sequence diagram can be similar to that of FIG. 14, except that a preferred network slice is not part of the configured network slices (e.g., is unidentified in a configured NSSAI list). Here also, the sequence diagram involves an application processor 1310 of a UE (e.g., the UE 104), a baseband processor 1320 of the UE, and a network 1330 (e.g., including the RAN 110 and the core network 112). The sequence diagram can be performed during the proactive slice need prediction 1020 and proactive registration 1030 of FIG. 10.

In a first step of the sequence diagram, the application processor 1410 proactively determines preferred NSSAI, indicating preferred network slices (or, equivalently, proactively determines a preferred application (e.g., an uninstalled application or an unlaunched application) or an application category, each of which can be associated with an NSSAI). The application processor 1410 can check the preferred NSSAI against allowed NSSAI (and/or application categories in the preferred NSSAI against URSP rules) and determine that no match exists between allowed network slices and the preferred network slices (or between already supported applications or application categories and preferred applications or preferred application categories).

In a second step of the sequence diagram, the application processor 1410 notifies the baseband processor of the preferred NSSAI (or the preferred application or preferred application category). For instance, the application processor 1410 sends a request to the baseband processor that identifies a preferred network slice (e.g., S_NSSAI_20 for the sake of example; or that identifies the preferred application or preferred application category), where this request can trigger a registration of the preferred network slice.

In a third step of the sequence diagram, the baseband processor 1420 determines that the requested network slice is not configured. For example, the baseband processor 1420 determines that S-NSSAI_20 is not identified in a configured NSSAI list. If the preferred application or preferred application category are identified to the baseband processor 1420 instead of the preferred network slice, the baseband processor 1420 can determine this slice based on preferred application or preferred application category.

In a fourth step of the sequence diagram, a subscription of the UE with the network 1430 is updated. This update indicates that the network slice is now subscribed (or a related service is subscribed). It may be possible that the subscription is completed via a user interface of the UE and can rely on a function executed by the application processor 1410. If so, the application processor determines that the subscription has occurred (e.g., S-NSSAI_10 is now supported by the subscription). Nonetheless, such a determination may not be needed.

In a fifth step of the sequence diagram, the baseband processor 1420 sends a mobility registration request to the network 1420. This request can be initiated due to any trigger (e.g., an RRC connection, reconnection, handover, etc.). Further, this request need not identify the network slice (e.g., need not include S-NSSAI_20). In response, and in a sixth step of the sequence diagram, the network 1430 can return a mobility registration accept message. Because the network slice has been subscribed to, this response can indicate that updated configured NSSAI includes S-NSSAI_20. As such, the baseband processor 1420 updates its stored configured NSSAI to include S-NSSAI_20. The updated configured NSSAI can be represent a trigger for a mobility registration, where this registration can include the preferred NSSAI.

Because this network slice is now configured and was previously requested by the application processor 1410 as a preferred slice, in a seventh step of the sequence diagram, the baseband processor 1420 sends a mobility registration request to the network 1430 (e.g., via the base station 108). Here, the baseband processor 1420 can check the set of conditions (described in FIG. 13) and, if satisfied, sends the mobility registration request. The mobility registration request can indicate requested NSSAI that includes S-NSSAI_20. Upon processing this request (e.g., by authenticating it, checking the subscription related to the UE and other parameters), in an eighth step of the sequence diagram, the network 1430 can return a mobility registration accept. This response can indicate that allowed NSSAI includes S-NSSAI_20.

In a nineth step of the sequence diagram, the baseband processor 1420 indicates to the application processor 1410 that the preferred network slice is now allowed. For example, the baseband processor 1420 returns an allowed NSSAI list that includes S-NSSAI_20.

In turn, and in a tenth step of the sequence diagram, the application processor 1410 initiates the use of the network slice. As illustrated, the application processor 1410 starts a data call request to the baseband processor 1420, where this request includes S-NSSAI_20.

In an eleventh step of the sequence diagram, the baseband processor 1420 sends a PDU session establishment request to the network. This request identifies the network slice (e.g., includes S-NSSAI_20). Upon processing this request (e.g., by authenticating it, checking the subscription related to the UE and other parameters), in a twelfth step of the sequence diagram, the network 1430 can return a PDU session establishment accept. This response can indicate that the PDU session is to use the network slice (e.g., the response includes S-NSSAI_20).

In a thirteenth step of the sequence diagram, the baseband processor 1420 indicates to the application processor 1410 that the call request is accepted. For example, the baseband processor 1420 returns a start call data accept message that includes S-NSSAI_20. In a fourteenth step, the application processor 1410 can exchange data with the network. The exchange can rely on the applicable URSP rule, indicating that the routing needs to occur over the network slice. The routing can be via the baseband processor 1420.

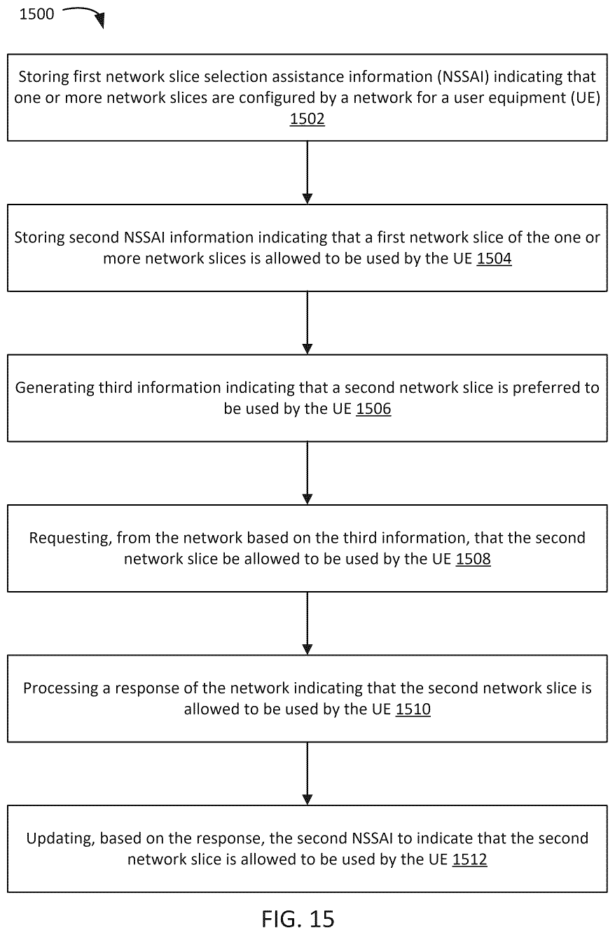

FIG. 15 illustrates an example of an operational flow/algorithmic structure 1500 for proactively enabling a network slice, in accordance with some embodiments. The operational flow/algorithmic structure 1500 can be implemented by any of the UEs described herein (or component(s) thereof). In some embodiments, the operational flow/algorithmic structure 1500 may be implemented by executing instructions stored in a tangible, non-transitory, computer-readable storage medium, such as a memory of the UE. While the operational flow/algorithmic structure 1500 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 1500 includes at 1502, storing first network slice selection assistance information (NSSAI) indicating that one or more network slices are configured by a network for a user equipment (UE). For instance, the first NSSAI is configured NSSAI received from a network (e.g., via a base station) in a mobility registration accept message. The second NSSAI can be stored in a memory of the UE as a configured NSSAI link and can identify the one or more network slices.

In an example, the operational flow/algorithmic structure 1500 includes at 1504, storing second NSSAI information indicating that a first network slice of the one or more network slices is allowed to be used by the UE. For instance, the second NSSAI is allowed NSSAI received from the network (e.g., via the base station) in a mobility registration accept message. The second NSSAI can be stored in the memory of the UE as an allowed NSSAI link and can identify the first network slice.

In an example, the operational flow/algorithmic structure 1500 includes at 1506, generating third information indicating that a second network slice is preferred to be used by the UE. For instance, the third information includes preferred NSSAI and can be generated proactively, including prior to an application installation, using any of the techniques described in FIG. 10. The third information can be stored in the memory of the UE as a preferred NSSAI list that identifies the second network slice.

In an example, the operational flow/algorithmic structure 1500 includes at 1508, requesting, from the network based on the third information, that the second network slice be allowed to be used by the UE. For instance, the UE determines whether the second network slice is not allowed and configured or is not configured. In the former case, the request can be sent in a manner similar to the sequence diagram of FIG. 13. In the latter case, the request can be sent in a manner similar to the sequence diagram of FIG. 14. The request can be a mobility registration request that identifies the second network slice and that is sent upon a determination that a set of conditions is met.

In an example, the operational flow/algorithmic structure 1500 includes at 1510, processing a response of the network indicating that the second network slice is allowed to be used by the UE. For instance, the response can be a mobility registration accept that indicates that the second network slice is now an allowed network slice.

In an example, the operational flow/algorithmic structure 1500 includes at 1512, updating, based on the response, the second NSSAI to indicate that the second network slice is allowed to be used by the UE. For instance, the stored allowed NSSAI list is updated to identify the second network slice. This operation can be completed prior to the application installation. As such, once the application is installed, the UE can initiate the use of the second network slice immediately.

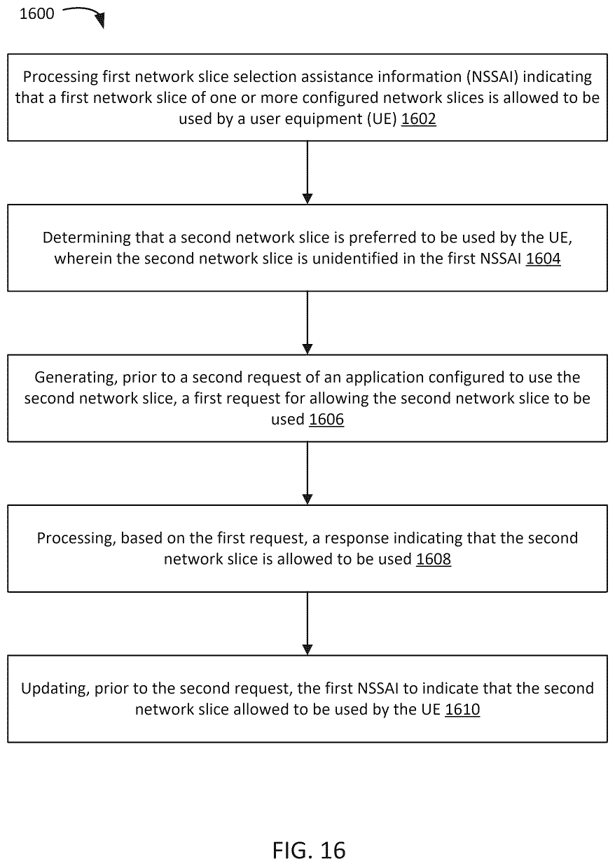

FIG. 16 illustrates an example of an operational flow/algorithmic structure 1600 for proactively determining that a network slice is to be allowed, in accordance with some embodiments. The operational flow/algorithmic structure 1600 can be implemented by a component (e.g., an application processor) any of the UEs described herein. In some embodiments, the operational flow/algorithmic structure 1600 may be implemented by executing instructions stored in a tangible, non-transitory, computer-readable storage medium, such as a memory of the UE. While the operational flow/algorithmic structure 1600 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 1600 includes at 1602, processing first network slice selection assistance information (NSSAI) indicating that a first network slice of one or more configured network slices is allowed to be used by a user equipment (UE). For instance, the first NSSAI is allowed NSSAI received from a network (e.g., via the base station) in a mobility registration accept message. The first NSSAI can be stored in a memory of the UE as an allowed NSSAI link and can identify the first network slice.

In an example, the operational flow/algorithmic structure 1600 includes at 1604, determining that a second network slice is preferred to be used by the UE, wherein the second network slice is unidentified in the first NSSAI. For instance, the second network slice is a preferred network slice that the application processor identifies by using any of the techniques described in FIG. 10.

In an example, the operational flow/algorithmic structure 1600 includes at 1606, generating, prior to a second request of an application configured to use the second network slice, a first request for allowing the second network slice to be used. Here, the application may not be installed yet on the UE, or if installed, may not have been launched yet. Thus, no request by the UE is made. The first request can be sent to a baseband processor of the UE, can identify the second network slice, and request this slice to be allowed.

In an example, the operational flow/algorithmic structure 1600 includes at 1608, processing, based on the first request, a response indicating that the second network slice is allowed to be used. For instance, the response is received from the baseband processor and indicates that the second network slice is not allowed. The response can be sent by the baseband processor upon a registration by the baseband processor of the second network slice with the network.

In an example, the operational flow/algorithmic structure 1600 includes at 1610, updating, prior to the second request, the first NSSAI to indicate that the second network slice allowed to be used by the UE. For instance, the stored allowed NSSAI list is updated to identify the second network slice. This operation can be completed prior to the application installation or launch (and, thus, prior to the second request). As such, once the second request is made is installed, the application processor can initiate the use of the second network slice immediately.

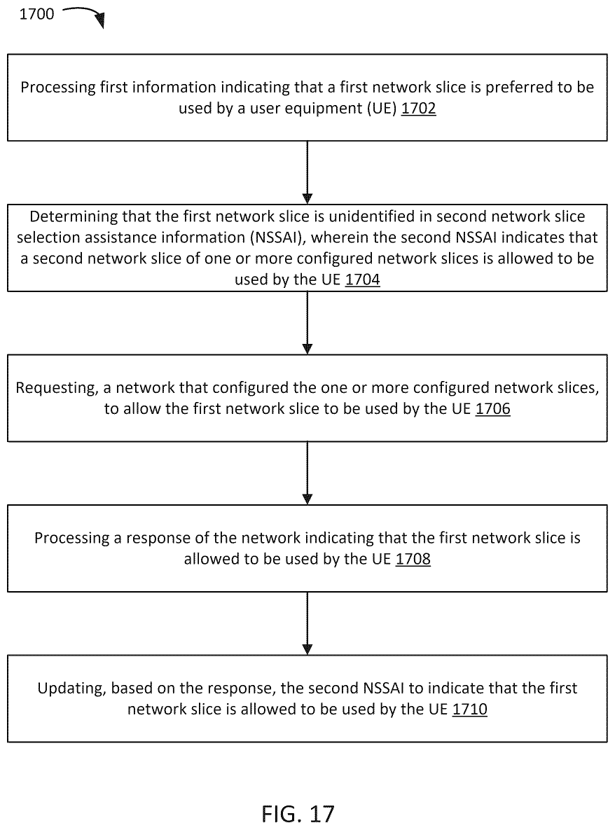

FIG. 17 illustrates an example of an operational flow/algorithmic structure for proactively allowing a network slice, in accordance with some embodiments. The operational flow/algorithmic structure 1700 can be implemented by a component (e.g., a baseband processor) any of the UEs described herein. In some embodiments, the operational flow/algorithmic structure 1700 may be implemented by executing instructions stored in a tangible, non-transitory, computer-readable storage medium, such as a memory of the UE. While the operational flow/algorithmic structure 1700 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 1700 includes at 1702, processing first information indicating that a first network slice is preferred to be used by a user equipment (UE). For instance, the first information includes preferred NSSAI that identifies the first network slice and is received from an application processor of the UE.

In an example, the operational flow/algorithmic structure 1700 includes at 1704, determining that the first network slice is unidentified in second network slice selection assistance information (NSSAI), wherein the second NSSAI indicates that a second network slice of one or more configured network slices is allowed to be used by the UE. For instance, the second NSSAI is allowed NSSAI received from a network (e.g., via the base station) in a mobility registration accept message. The second NSSAI can be stored in the memory of the UE as an allowed NSSAI link and can identify the second network slice. Further, configured NSSAI can be received from the network (via the base station) in a mobility registration accept message and can indicate the one or more configured network slices. The configured NSSAI can be stored in the memory of the UE as a configured NSSAI link.

In an example, the operational flow/algorithmic structure 1700 includes at 1706, requesting, a network that configured the one or more configured network slices, to allow the first network slice to be used by the UE. For instance, because the first network slice was requested and because it is configured (e.g., identified in the configured NSSAI list) and is not allowed (e.g., unidentified in the allowed NSSAI list), the baseband processor can determine that a mobility registration request is to be triggered. The baseband processor can send mobility registration request to the network, where this request can identify the first network slice as a slice requested to be allowed. This request can be sent upon the baseband processor determining that a set of conditions is met. Further, if the first network slice is not already configured, the baseband processor may not send this mobility registration request until receiving an indication from the network (e.g., in another mobility registration message exchange) that the first network slice is configured.

In an example, the operational flow/algorithmic structure 1700 includes at 1708, processing a response of the network indicating that the first network slice is allowed to be used by the UE. For instance, the response can correspond to a mobility registration accept message that identifies the first network slice and indicates that this slice is allowed.

In an example, the operational flow/algorithmic structure 1700 includes at 1710, updating, based on the response, the second NSSAI to indicate that the first network slice is allowed to be used by the UE. For instance, the response indicates updated allowed NSSAI. The UE can store the updated allowed NSSAI as an updated NSSAI list that identifies the first network slice. The above operations of the operational flow/algorithmic structure 1700 can be completed prior to an application installation or launch. As such, once the application is installed or launched, the UE can initiate the use of the second network slice immediately.

The above embodiments provide various technical advantages. For example, if a user installs a new application which maps to a network slice that the UE is not currently registered to, the UE-initiated network slice modification allows immediate data access using the application. Upon a change to the relevant subscription, the updated configured NSSAI from the network can be used to immediately request new network slices usable by the installed applications. The user does not need to wait for other triggers for the UE to trigger mobility registration to access data for requesting new network slices used by the installed applications. The baseband processor can ensure the requested network slices are prioritized while sending requested NSSAI as part of registration request during subsequent re-registrations due to other triggers (such as a tracking area change) so that baseband processor remains registered to the relevant network slices.

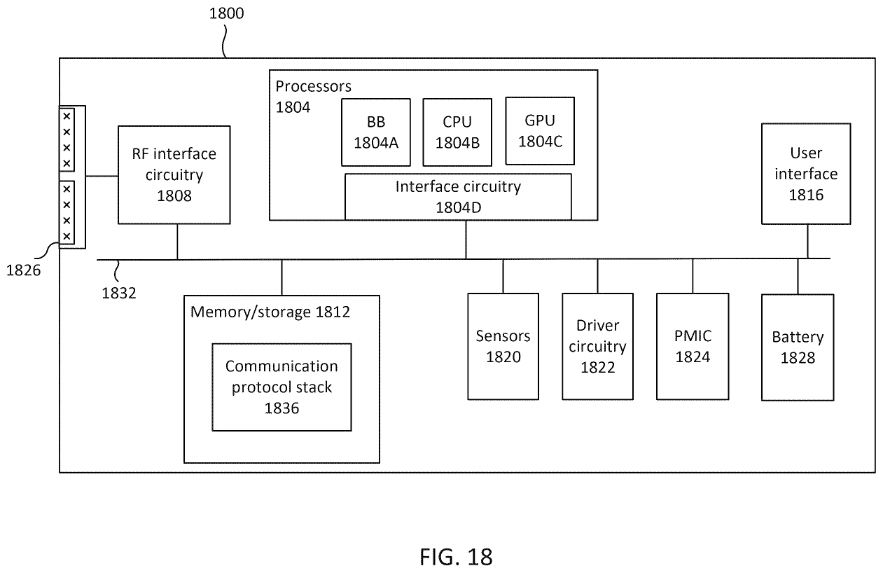

FIG. 18 illustrates a UE 1800 in accordance with some embodiments. The UE 1800 may be similar to and substantially interchangeable with the UE 104.

The UE 1800 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smartwatch), or Internet-of-things devices.

The UE 1800 may include processors 1804, RF interface circuitry 1808, memory/storage 1812, user interface 1816, sensors 1820, driver circuitry 1822, power management integrated circuit (PMIC) 1824, antenna 1826, and battery 1828. The components of the UE 1800 may be implemented as integrated circuits (ICs), portions thereof, discrete electronic devices, or other modules, logic, hardware, software, firmware, or a combination thereof. The block diagram of FIG. 18 is intended to show a high-level view of some of the components of the UE 1800. However, some of the components shown may be omitted, additional components may be present, and different arrangements of the components shown may occur in other implementations.

The components of the UE 1800 may be coupled with various other components over one or more interconnects 1832, which may represent any type of interface, input/output, bus (local, system, or expansion), transmission line, trace, or optical connection that allows various circuit components (on common or different chips or chipsets) to interact with one another.

The processors 1804 may include processor circuitry such as, for example, baseband processor circuitry (BB) 1804A, central processor unit circuitry (CPU) 1804B, and graphics processor unit circuitry (GPU) 1804C. The processors 1804 may include any type of circuitry or processor circuitry that executes or otherwise operates computer-executable instructions, such as program code, software modules, or functional processes from memory/storage 1812 to cause the UE 1800 to perform operations as described herein. The processors 1804 may also include interface circuitry 1804D to communicatively couple the processor circuitry with one or more other components of the UE 1800.

In some embodiments, the baseband processor circuitry 1804A may access a communication protocol stack 1836 in the memory/storage 1812 to communicate over a 3GPP-compatible network. In general, the baseband processor circuitry 1804A may access the communication protocol stack 1836 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1808.

The baseband processor circuitry 1804A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1812 may include one or more non-transitory, computer-readable media that includes instructions (for example, communication protocol stack 1836) that may be executed by one or more of the processors 1804 to cause the UE 1800 to perform various operations described herein.

The memory/storage 1812 includes any type of volatile or non-volatile memory that may be distributed throughout the UE 1800. In some embodiments, some of the memory/storage 1812 may be located on the processors 1804 themselves (for example, memory/storage 1812 may be part of a chipset that corresponds to the baseband processor circuitry 1804A), while other memory/storage 1812 is external to the processors 1804 but accessible thereto via a memory interface. The memory/storage 1812 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1808 may include transceiver circuitry and a radio frequency front module (RFEM) that allows the UE 1800 to communicate with other devices over a radio access network. The RF interface circuitry 1808 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1826 and proceed to filter and amplify (with a low-noise amplifier) the signal. The signal may be provided to a receiver of the transceiver that down-converts the RF signal into a baseband signal that is provided to the baseband processor of the processors 1804.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1826.

In various embodiments, the RF interface circuitry 1808 may be configured to transmit/receive signals in a manner compatible with NR access technologies.

The antenna 1826 may include antenna elements to convert electrical signals into radio waves to travel through the air and to convert received radio waves into electrical signals. The antenna elements may be arranged into one or more antenna panels. The antenna 1826 may have antenna panels that are omnidirectional, directional, or a combination thereof to enable beamforming and multiple input, multiple output communications. The antenna 1826 may include microstrip antennas, printed antennas fabricated on the surface of one or more printed circuit boards, patch antennas, or phased array antennas. The antenna 1826 may have one or more panels designed for specific frequency bands including bands in FR1 or FR2.

The user interface 1816 includes various input/output (I/O) devices designed to enable user interaction with the UE 1800. The user interface 1816 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1800.

The sensors 1820 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1822 may include software and hardware elements that operate to control particular devices that are embedded in the UE 1800, attached to the UE 1800, or otherwise communicatively coupled with the UE 1800. The driver circuitry 1822 may include individual drivers allowing other components to interact with or control various input/output (I/O) devices that may be present within or connected to the UE 1800. For example, driver circuitry 1822 may include a display driver to control and allow access to a display device, a touchscreen driver to control and allow access to a touchscreen interface, sensor drivers to obtain sensor readings of sensors 1820, and control and allow access to sensors 1820, drivers to obtain actuator positions of electro-mechanic components or control and allow access to the electro-mechanic components, a camera driver to control and allow access to an embedded image capture device, audio drivers to control and allow access to one or more audio devices.

The PMIC 1824 may manage power provided to various components of the UE 1800. In particular, with respect to the processors 1804, the PMIC 1824 may control power-source selection, voltage scaling, battery charging, or DC-to-DC conversion.

A battery 1828 may power the UE 1800, although in some examples, the UE 1800 may be mounted deployed in a fixed location and may have a power supply coupled to an electrical grid. The battery 1828 may be a lithium-ion battery, a metal-air battery, such as a zinc-air battery, an aluminum-air battery, a lithium-air battery, and the like. In some implementations, such as in vehicle-based applications, the battery 1828 may be a typical lead-acid automotive battery.

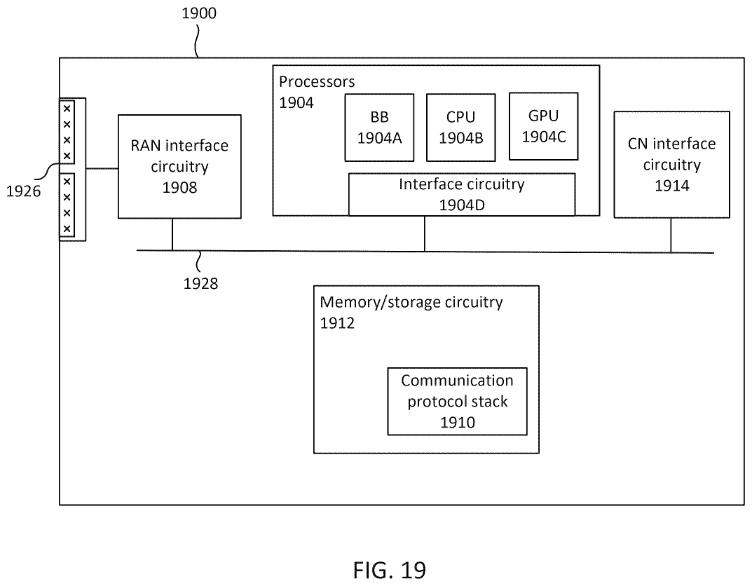

FIG. 19 illustrates a network device 1900 in accordance with some embodiments.

The network device 1900 may be similar to and substantially interchangeable with base station 108.

The network device 1900 may include processors 1904, RF interface circuitry 1908 (if implemented as a base station), core network (CN) interface circuitry 1914, memory/storage circuitry 1912, and antenna structure 1926.

The components of the network device 1900 may be coupled with various other components over one or more interconnects 1928.

The processors 1904, RF interface circuitry 1908, memory/storage circuitry 1912 (including communication protocol stack 1910), antenna structure 1926, and interconnects 1928 may be similar to like-named elements shown and described with respect to FIG. 10.

The processors 1904 may include processor circuitry such as, for example, baseband processor circuitry (BB) 1904A, central processor unit circuitry (CPU) 1904B, and graphics processor unit circuitry (GPU) 1904C. The processors 1904 may include any type of circuitry or processor circuitry that executes or otherwise operates computer-executable instructions, such as program code, software modules, or functional processes from memory/storage circuitry 1912 to cause the UE 1800 to perform operations as described herein. The processors 1904 may also include interface circuitry 1904D to communicatively couple the processor circuitry with one or more other components of the network device 1900.

The CN interface circuitry 1914 may provide connectivity to a core network, for example, a 5th Generation Core network (5GC) using a 5GC-compatible network interface protocol such as carrier Ethernet protocols or some other suitable protocol. Network connectivity may be provided to/from the network device 1900 via a fiber optic or wireless backhaul. The CN interface circuitry 1914 may include one or more dedicated processors or FPGAs to communicate using one or more of the aforementioned protocols. In some implementations, the CN interface circuitry 1914 may include multiple controllers to provide connectivity to other networks using the same or different protocols.

It is well understood that the use of personally identifiable information should follow privacy policies and practices generally recognized as meeting or exceeding industry or governmental requirements for maintaining users' privacy. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry described above in connection with one or more of the preceding figures may be configured to operate according to one or more of the examples set forth below. For another example, circuitry associated with a UE, base station, or network element described above in connection with one or more of the preceding figures may be configured to operate according to one or more of the examples set forth below in the example section.

### Examples

In the following sections, further exemplary embodiments are provided.
Example 1 includes a method including: identifying a quality of experience (QoE) parameter; selecting a first packet data unit (PDU) session based on the QoE parameter; determining a set of candidate slices that support the first PDU session; determining whether a slice of the set of candidate slices meets the QoE parameter; and selecting the slice or a second PDU session based on said determining of whether the slice of the set of candidate slices meets the QoE parameter.
Example 2 includes the method of example 1 or some other examples herein, wherein the QoE parameter comprises a preferred: bandwidth, bit rate, latency, or reliability.
Example 3 includes the method of examples 1 or 2 or some other example herein, wherein the QoE parameter further comprises one or more of: a pricing preference, a billing policy, a modification limitation, or an overhead management parameter.
Example 4 includes the method of any of examples 1-3 or some other example herein, the method further including: selecting the slice of the set of candidate slices based on: a measurement associated with the QoE parameter; training data; or an order of the set of candidate slices.
Example 5 includes the method of any of examples 1˜4 or some other example herein, wherein determining whether the slice meets the QoE parameter comprises determining that the slice does not meet the QoE parameter, and the method includes: selecting the second PDU session based on determining that the slice does not meet the QoE parameter.
Example 6 includes the method of any of examples 1-5 or some other example herein, wherein determining whether the slice meets the QoE parameter comprises determining that the slice meets the QoE parameter and the method includes: selecting the slice based on determining that the slice meets the QoE parameter.
Example 7 includes the method of any of examples 1-6 or some other example herein, further including: detecting a networking condition; and identifying a configured PDU session associated with the condition; identifying a configured slice associated with the configured PDU session or the condition; and selecting the configured PDU session and the configured slice.
Example 8 includes the method of any of examples 1-7 or some other example herein, wherein detecting the networking condition includes: after determining that the slice meets the QoE parameter determining that the slice does not meet the QoE parameter; or determining that a measurement of the slice is smaller than a threshold associated with the configured PDU session or the configured slice.
Example 9 includes the method of any of examples 1-8 or some other example herein, wherein said detecting the networking condition includes: determining a change in the QoE parameter.
Example 10 includes the method of any of examples 1-9 or some other example herein, wherein the change in the QoE parameter comprises a change in real-time QoE, a change in a quality of service (QOS) flow, or a change in an application category.
Example 11 includes the method of any of examples 1-10 or some other example herein, further including: monitoring a networking condition; and reconfiguring the PDU based on the networking condition.
Example 12 includes the method of any of examples 1-11 or some other example herein, wherein the networking condition comprises a change in real-time QoE, a change in a quality of service (QOS) flow, or a change in an application category.
Example 13 includes the method of any of examples 1-12 or some other example herein, wherein said reconfiguring the PDU session includes: adding, removing, or reconfiguring a flow in the PDU session.
Example 14 includes the method of any of examples 1-13 or some other example herein, further including: identifying a first slice from a first set of slices and a second slice from a second set of slices; and switching between the first slice and the second slice.
Example 15 includes the method of any of examples 1-14 or some other example herein, wherein the QoE parameter is an end-to-end QoE.
Example 16 includes a method including: processing a list of slices; mapping application data traffic to a first slice from the list of slices; determining an indication; selecting a second slice from the list of slices based on the indication; and mapping the application data traffic to the second slice.
Example 17 includes the method of example 16 or some other example herein, wherein the indication is associated with one or more of: a change in the application data traffic; a message received from a network; a quality of experience (QoE) or a quality of service (Qos) parameter; a measurement; a short-term billing parameter; a service duration; a radio link condition; or an application state.
Example 18 includes the method of examples 16 or 17 or some other example herein, wherein the indication is estimated or monitored.
Example 19 includes a method including: identifying a slice; and reconfiguring the slice based on an indication.
Example 20 includes the method of example 19 or some other example herein, wherein the indication is associated with one or more of: an application data traffic; a message received from a network; a quality of experience (QoE) or a quality of service (QOS) parameter; a measurement; a short-term billing parameter; a service duration; a radio link condition; or an application state.
Example 21 includes the method of examples 19 or 20 or some other example herein, wherein the indication is estimated or monitored
Example 22 includes a method, the method including: storing first network slice selection assistance information (NSSAI) indicating that one or more network slices are configured by a network for a user equipment (UE); storing second NSSAI information indicating that a first network slice of the one or more network slices is allowed to be used by the UE; generating third information indicating that a second network slice is preferred to be used by the UE; requesting, from the network based on the third information, that the second network slice be allowed to be used by the UE; processing a response of the network indicating that the second network slice is allowed to be used by the UE; and updating, based on the response, the second NSSAI to indicate that the second network slice is allowed to be used by the UE.
Example 23 includes a method, the method including: processing first network slice selection assistance information (NSSAI) indicating that a first network slice of one or more configured network slices is allowed to be used by a user equipment (UE); determining that a second network slice is preferred to be used by the UE, wherein the second network slice is unidentified in the first NSSAI; generating, prior to a second request of an application configured to use the second network slice, a first request for allowing the second network slice to be used; processing, based on the first request, a response indicating that the second network slice is allowed to be used; and updating, prior to the second request, the first NSSAI to indicate that the second network slice allowed to be used by the UE.
Example 24 includes a method, the method including: processing first information indicating that a first network slice is preferred to be used by a user equipment (UE); determining that the first network slice is unidentified in second network slice selection assistance information (NSSAI), wherein the second NSSAI indicates that a second network slice of one or more configured network slices is allowed to be used by the UE; requesting, a network that configured the one or more configured network slices, to allow the first network slice to be used by the UE; processing a response of the network indicating that the first network slice is allowed to be used by the UE; and updating, based on the response, the second NSSAI to indicate that the first network slice is allowed to be used by the UE.
Example 25 includes the method of any example 21-24 or some other examples herein, wherein the third information corresponds to a preferred NSSAI list, and wherein requesting that the second network slice be allowed comprises sending a mobility registration request based on the preferred NSSAI list.
Example 26 includes the method of any example 21-25 or some other examples herein, wherein the mobility registration request identifies the second network slice and is sent based on the second network slice being one of the one or more network slices configured for the UE.
Example 27 includes the method of any example 21-26 or some other examples herein, wherein the third information is generated prior to a first application being installed on the UE, and wherein the method further comprises: sending, by using the second network slice, traffic of the first application to the network upon an installation of the first application on the UE.
Example 28 includes the method of any example 21-27 or some other examples herein, wherein the third information is generated for a category of applications based on a second application already installed on the UE and being of the category of applications, wherein the first application is of the category of applications.
Example 29 includes the method of any example 21-28 or some other examples herein, wherein the second network slice is determined and the first request is generated prior to the application being installed on the UE.
Example 30 includes the method of any example 21-29 or some other examples herein, wherein the second network slice is determined based on one or more applications already installed on the UE prior to the first request.
Example 31 includes the method of any example 21-30 or some other examples herein, wherein the second network slice is determined based on a subscription with the network, the subscription already existing prior to the first request and associated with a subscription identity module of the UE.
Example 32 includes the method of any example 21-31 or some other examples herein, wherein the second network slice is determined based on usage of one or more applications of the UE, the usage being prior to the first request.
Example 33 includes the method of any example 21-32 or some other examples herein, wherein the second network slice is determined based on an availability of a service of a network to the UE, the service being available prior to the first request.
Example 34 includes the method of any example 21-33 or some other examples herein, wherein the second network slice is determined based on using an input to an artificial intelligence machine learning model executing on the UE, wherein the input includes at least one of: time of day, UE location, or network connectivity status.
Example 35 includes the method of any example 21-34 or some other examples herein, further comprising: determining a category of applications based on installation of one or more applications on the UE or usage of the one or more applications, wherein the application is of the category; and determining a UE route selection policy (URSP) rule based on the category, wherein the URSP rule identifies the category and does not identify any specific application to which the URSP rule applies, wherein the first request is generated based on the URSP.
Example 36 includes the method of any example 21-35 or some other examples herein, wherein the method further comprises: determining that a set of conditions to request the first network slice to be allowed is stratified, wherein the network is requested to allow the first network slice based on the set of conditions being satisfied.
Example 37 includes the method of any example 21-36 or some other examples herein, wherein the first information corresponds to a preferred NSSAI list, wherein the second NSSAI corresponds to an allowed NSSAI list, and wherein the set of conditions is satisfied upon a determination that the allowed NSSAI list includes one or more single NSSAIs (S-NSSAIs) absent from the preferred NSSAI list.
Example 38 includes the method of any example 21-37 or some other examples herein, wherein the second NSSAI corresponds to an allowed NSSAI list, and wherein the set of conditions is satisfied upon a determination that a length of the allowed NSSAI list is smaller than a maximum length.
Example 39 includes the method of any example 21-38 or some other examples herein, wherein the set of conditions is satisfied upon a determination that the UE is operating in an idle mode.
Example 40 includes the method of any example 21-39 or some other examples herein, wherein the first information corresponds to a preferred NSSAI list, and wherein the set of conditions is satisfied upon a determination that the preferred NSSAI list includes a single NSSAI (S-NSSAI) absent from a configured NSSAI list.
Example 41 includes the method of any example 21-40 or some other examples herein, wherein the first information corresponds to a preferred NSSAI list, wherein the second NSSAI corresponds to an allowed NSSAI list, and wherein the method further comprises: determining, at a first time, that the first network slice unidentified in a configured NSSAI list; forgoing registering the first network slice with the network; processing an update of the network to the configured NSSAI list; determining, at a second time, that the first network slice identified in the update; triggering, based on the first network slice being identified in the update and in the preferred NSSAI list, a mobility registration with the network, the mobility registration identifying the first network slice; and updating the allowed NSSAI list to identify the first network slice based on the mobility registration.

Another example may include an apparatus comprising means to perform one or more elements of a method described in or related to any of examples 1-41, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-41, or any other method or process described herein.

Another example may include an apparatus comprising logic, modules, or circuitry to perform one or more elements of a method described in or related to any of examples 1-21, or any other method or process described herein.

Another example may include a method, technique, or process as described in or related to any of examples 1-41, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-41, or portions thereof.

Another example may include a signal as described in or related to any of examples 1-41, or portions or parts thereof.

Another example may include a datagram, information element, packet, frame, segment, PDU, or message as described in or related to any of examples 1-41, or portions or parts thereof, or otherwise described in the present disclosure.

Another example may include a signal encoded with data as described in or related to any of examples 1-41, or portions or parts thereof, or otherwise described in the present disclosure.

Another example may include a signal encoded with a datagram, IE, packet, frame, segment, PDU, or message as described in or related to any of examples 1-41, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-41, or portions thereof.

Another example may include a computer program comprising instructions, wherein execution of the program by a processing element is to cause the processing element to carry out the method, techniques, or process as described in or related to any of examples 1-41, or portions thereof.

Another example may include a signal in a wireless network as shown and described herein.

Another example may include a method of communicating in a wireless network, as shown and described herein.

Another example may include a system for providing wireless communication, as shown and described herein.

Another example may include a device for providing wireless communication, as shown and described herein.

Unless explicitly stated otherwise, any of the above-described examples may be combined with any other example (or combination of examples). The foregoing description of one or more implementations provides illustration and description but is not intended to be exhaustive or to limit the scope of embodiments to the precise form disclosed. Modifications and variations are possible in light of the above teachings or may be acquired from the practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
identifying a quality of experience (QoE) parameter;
selecting a first packet data unit (PDU) session based on the QoE parameter;
determining a set of candidate slices that support the first PDU session;
determining whether a slice of the set of candidate slices meets the QoE parameter; and
selecting the slice or a second PDU session based on said determining of whether the slice of the set of candidate slices meets the QoE parameter.

2. The method of claim 1, wherein the QoE parameter comprises:
a preferred: bandwidth, bit rate, latency, or reliability; or
one or more of: a pricing preference, a lifespan, a billing policy, a modification limitation, or an overhead management parameter.

3. The method of claim 1, further comprising:
selecting the slice of the set of candidate slices based on: a measurement associated with the QoE parameter; training data; loading information; or an order of the set of candidate slices.

4. The method of claim 1, wherein determining whether the slice meets the QoE parameter comprises determining that the slice does not meet the QoE parameter, and the method comprises:
selecting the second PDU session based on determining that the slice does not meet the QoE parameter.

5. The method of claim 1, wherein determining whether the slice meets the QoE parameter comprises determining that the slice meets the QoE parameter and the method comprises:
selecting the slice based on determining that the slice meets the QoE parameter.

6. The method of claim 5, further comprising:
identifying a first slice from a first set of slices and a second slice from a second set of slices; and
switching between the first slice and the second slice.

7. The method of claim 5, further comprising:
monitoring a networking condition; and
reconfiguring the PDU based on the networking condition.

8. The method of claim 7, wherein the networking condition comprises a change in real-time QoE, a change in a quality of service (QOS) flow, or a change in an application category.

9. The method of claim 7, wherein said reconfiguring the PDU session comprises:
adding, removing, or reconfiguring a flow in the PDU session.

10. The method of claim 5, further comprising:
detecting a networking condition; and
identifying a configured PDU session associated with the condition;
identifying a configured slice associated with the configured PDU session or the condition; and
selecting the configured PDU session and the configured slice.

11. The method of claim 10, wherein detecting the networking condition comprises:
after determining that the slice meets the QoE parameter determining that the slice does not meet the QoE parameter; or
determining that a measurement of a service of the slice is smaller than a threshold.

12. The method of claim 11, wherein the threshold is based on the QoE parameter.

13. The method of claim 10, wherein said detecting the networking condition comprises:
determining a change in the QoE parameter.

14. The method of claim 13, wherein the change in the QoE parameter comprises a change in real-time QoE, a change in a quality of service (QOS) flow, or a change in an application category.

15. A method comprising:
storing first network slice selection assistance information (NSSAI) indicating that one or more network slices are configured by a network for a user equipment (UE);
storing second NSSAI information indicating that a first network slice of the one or more network slices is allowed to be used by the UE;
generating third information indicating that a second network slice is preferred to be used by the UE;
requesting, from the network based on the third information, that the second network slice be allowed to be used by the UE;
processing a response of the network indicating that the second network slice is allowed to be used by the UE; and
updating, based on the response, the second NSSAI to indicate that the second network slice is allowed to be used by the UE.

16. The method of claim 15, wherein
the third information corresponds to a preferred NSSAI list, and wherein requesting that the second network slice be allowed comprises sending a mobility registration request based on the preferred NSSAI list; and
the mobility registration request identifies the second network slice and is sent based on the second network slice being one of the one or more network slices configured for the UE.

17. The method of claim 16, wherein the third information is generated prior to a first application being installed on the UE, and wherein the method further comprises:
sending, by using the second network slice, traffic of the first application to the network upon an installation of the first application on the UE.

18. A method comprising:
receiving a request from a user equipment (UE) for an on-demand slice configuration, the request including measurements, configuration information, quality of service (QoS) or quality of experience (QoE) parameters; and
generating an activation message to enable a pre-configured slice for the UE based on the request.

19. The method of claim 18, wherein generating the activation or reconfiguration message includes dynamically allocating network resources to meet a quality of service (QOS) or a quality of experience (QoE) parameter included in the request.

20. The method of claim 18, wherein the pre-configured slice is a first pre-configured slice, and the method further comprises:
detecting a change in one or more of load variations, billing policies, or service disruptions; and
generating a reconfiguration message for a second pre-configured slice based on said detecting the change.
